(19) United States
(12) Patent Application Publication
(10) Pub. No.: US 2026/0040238 A1
(43) Pub. Date: Feb. 5, 2026

(54) METHODS AND SYSTEMS FOR MANAGING TRANSMIT POWER

(71) Applicant: Comcast Cable Communications, LLC, Philadelphia, PA (US)

(72) Inventor: Richard PRODAN, Niwot, CO (US)

(21) Appl. No.: 19/288,917

(22) Filed: Aug. 1, 2025

Related U.S. Application Data
(60) Provisional application No. 63/678,271, filed on Aug. 1, 2024.

(51) Int. Cl. H04W 52/38; H04B 17/309; H04L 12/28

(52) U.S. Cl. CPC H04W 52/383; H04B 17/346; H04L 12/2801

(57) ABSTRACT

Methods and systems for managing transmit power are disclosed. A separate transmit power may be determined (e.g., based on a water-filling algorithm) for each of a plurality of channels. The plurality of upstream channels may be used to transmit upstream signals from a computing device to a network node in an upstream frequency band of a communication medium. The transmit power determined, based on the water-filling algorithm, for at least one channel of the plurality of channels may exceed an amount of transmit power required to achieve a first threshold signal-to-noise ratio (SNR) associated with the at least one channel at the network node. A portion of the transmit power determined, based on the water-filling algorithm, for the at least one channel may be re-allocated to at least one other channel of the plurality of channels, thereby increasing an average bit-loading across the plurality of channels.

### CROSS-REFERENCE TO RELATED APPLICATIONS

This application claims priority to and the benefit of U.S. Provisional Application No. 63/678,271, filed Aug. 1, 2024, the disclosure of which is hereby incorporated by reference in its entirety.

### BACKGROUND

Cable communication systems may utilize a hybrid fiber-coaxial (HFC) network architecture to provide services to user devices (e.g., cable modems), with upstream channels allowing the user devices to send data back to the network. Upstream transmit levels of the user devices may be set to cause a constant receive power versus frequency at the network (e.g., at the network node). However, if the upstream transmit levels of the user devices are set to cause a constant receive power versus frequency at the network, the available upstream spectrum may be underutilized.

### SUMMARY

Systems and methods for managing transmit power are described herein. A water-filling algorithm may be used to allocate a total upstream transmit power associated with a computing device across multiple upstream channels used to transmit upstream signals from the computing device to a network node. While the transmit power allocation determined based on the water-filling algorithm may increase utilization of the available upstream spectrum for the computing device (as compared to a transmit power allocation that causes a constant receive power versus frequency at the network node), the available upstream spectrum may still be underutilized if the transmit power determined, based on the water-filling algorithm, for at least one upstream channel exceeds an amount of transmit power required to achieve a threshold SNR at the network node. To further optimize the upstream capacity of the computing device, the transmit power allocation determined based on the water-filling algorithm may be modified by re-allocating a portion of the transmit power determined, based on the water-filling algorithm, for the upstream channel(s) to at least one other upstream channel. This modified transmit power allocation may increase the upstream capacity of the computing device (e.g., an average bit-loading across the upstream channels).

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

Additional advantages will be set forth in part in the description which follows or may be learned by practice. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 shows an example system.

FIG. 2A shows an example graph.

FIG. 2B shows an example table.

FIG. 2C shows an example graph.

FIG. 2D shows an example graph.

FIG. 2E shows an example table.

FIG. 3A shows an example graph.

FIG. 3B shows an example table.

FIG. 3C shows an example graph.

FIG. 3D shows an example graph.

FIG. 3E shows an example table.

FIG. 4 shows example table.

FIG. 5A shows an example chart.

FIG. 5B shows an example set of graphs.

FIG. 6A shows an example graph.

FIG. 6B shows an example table.

FIG. 6C shows an example graph.

FIG. 6D shows an example graph.

FIG. 6E shows an example table.

FIG. 7A shows an example graph.

FIG. 7B shows an example table.

FIG. 7C shows an example graph.

FIG. 7D shows an example graph.

FIG. 7E shows an example table.

FIG. 8A shows an example graph.

FIG. 8B shows an example table.

FIG. 8C shows an example graph.

FIG. 8D shows an example graph.

FIG. 8E shows an example table.

FIG. 9A shows an example graph.

FIG. 9B shows an example table.

FIG. 9C shows an example graph.

FIG. 9D shows an example graph.

FIG. 9E shows an example table.

FIG. 10 shows an example table.

FIG. 11 shows an example method.

FIG. 12 shows an example method.

FIG. 13 shows an example method.

FIG. 14 shows an example computing device.

### DETAILED DESCRIPTION

Cable communication systems may utilize a hybrid fiber-coaxial (HFC) network architecture to provide services to user devices (e.g., cable modems), with multiple upstream channels allowing the user devices to send data back to the network. Data over Cable Service Interface Specifications (DOCSIS) 4.0 technology may increase the bandwidth and the resultant throughput of the services provided to the user devices via the network, thereby providing a significant increase in the available spectrum, especially for the traffic transmitted upstream from the user devices back to the network via the upstream channels. However, upstream transmit levels of the user devices may be set to cause a constant receive power versus frequency at the network (e.g., at the network node). If the upstream transmit levels of the user devices are set to cause a constant receive power versus frequency at the network, the increase in available upstream spectrum may be underutilized (e.g., the full potential increase in capacity may not be achieved).

To better utilize the increase in available upstream spectrum for a user device, a water-filling algorithm, such as a geometric water-filling algorithm, may be used to allocate the total upstream transmit power associated with the user device across the multiple upstream channels. Allocating the total upstream transmit power associated with the user device across the multiple upstream channels may comprise maximizing a sum rate of all of the upstream channels using the Shannon channel capacity theorem. The sum rate of all of the upstream channels using the Shannon channel capacity theorem may be maximized based on the water-filling algorithm. However, while the transmit power allocation determined based on the water-filling algorithm may enable an increased utilization of the available upstream spectrum for the user device, the available upstream spectrum may still be underutilized (e.g., the full potential increase in capacity may still not be achieved). If the available upstream spectrum is underutilized, the average bit-loading across the upstream channels may not be maximized.

To further optimize the upstream capacity of the user device (and to increase the average bit-loading across the upstream channels), the transmit power allocation determined based on the water-filling algorithm may be modified based on individual peak power limits associated with each upstream channel. The individual peak power limits associated with each upstream channel may be derived from signal-to-noise ratio (SNR) thresholds for the orthogonal frequency-division multiplexing (OFDM) modulation orders. Higher-order OFDM modulations may pack more bits per symbol, but may be more susceptible to noise, requiring a higher threshold SNR for reliable communication. If the transmit power determined, based on the water-filling algorithm, for at least one of the upstream channels exceeds an amount of transmit power required to achieve a threshold SNR associated with one of the OFDM modulation orders, a portion of the transmit power determined, based on the water-filling algorithm, for the upstream channel(s) may be re-allocated to at least one other upstream channel, thereby increasing an average bit-loading across the upstream channels.

User devices utilizing either DOCSIS 4.0 full-duplex (FDX) or extended spectrum (ESD) DOCSIS specifications may benefit from this upstream capacity optimization technique, as the upstream spectrum using orthogonal frequency-division multiple access (OFDMA) transmission is the same under the DOCSIS 4.0 FDX specification and the ESD DOCSIS specification. It should be appreciated that a variety of network designs exist, and the techniques described herein are applicable to any of the network configurations in production hybrid-fiber-coax (HFC) networks.

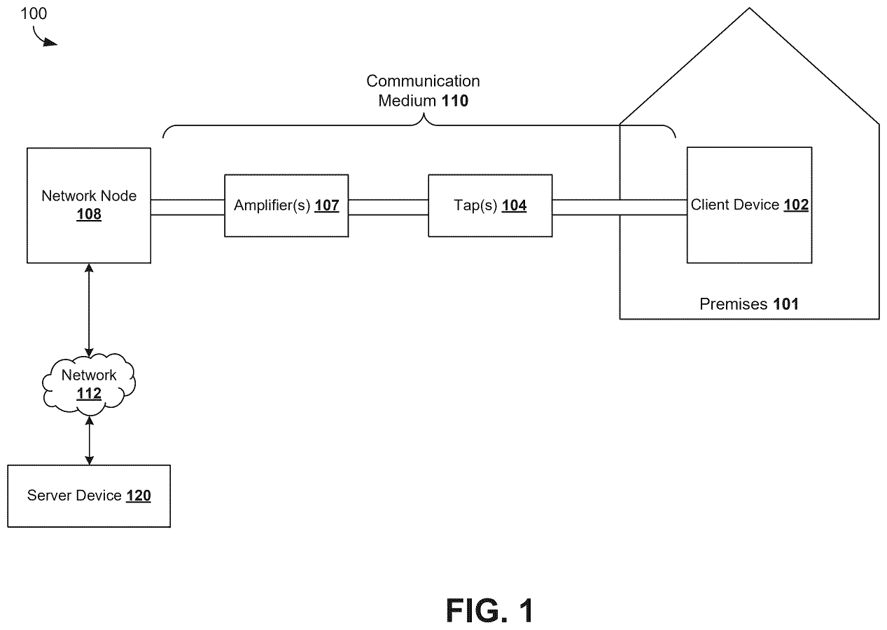

FIG. 1 shows an example system 100. The system 100 may comprise a network node 108, a client device 102, and a server device 120. The client device 102 may be located at a premises 101. The premises 101 may comprise a property, dwelling, terminal, building, floor, and/or the like. The client device 102 may be installed at a location at a premises 101, such as in a particular room at the premises 101. The client device 102 may be in communication with the network node 108 via a communication medium 110. The communication medium 110 may comprise, for example, a coaxial cable connection, or a HFC cable connection between the network node 108 and the premises 101. The coaxial cable or HFC cable connection may comprise one or more RF amplifiers 107 and one or more taps 104. The network node 108 may comprise a distributed access architecture (DAA) node. The network node 108 may receive signals via an optical fiber medium and may output electrical signals onto a coaxial cable. The amplifier(s) 107 may repeat the electrical signals until the electrical signals reach a tap 104 that is connected to the cable drop associated with the premises 101.

The server device 120 may be communicatively coupled with the network node 108 via one or more networks, such as a network 112 (e.g., a wide area network). The network 112 may comprise any of a variety of types of networks, such as, for example, a coaxial cable network, a fiber-optic cable network, a hybrid fiber-coaxial (HFC) network, a satellite transmission channel, a DSL connection, or the like. The network 112 may comprise fiber, cable, a combination thereof. The network 112 may comprise wired links, wireless links, a combination thereof, and/or the like. The network 112 may comprise one or more networks, such as a wide area network (e.g., the Internet), a cellular network, a Long Term Evolution (LTE) network, one or more service entity networks, and/or the like.

The client device 102 may be used to deliver one or more services, such as broadband service, to the premises 101. The client device 102 may comprise any computing device, such as a cable modem, a gateway device, or a router device, that is compliant with DOCSIS 4.0. For example, the client device 102 may comprise a client device that is compliant with DOCSIS 4.0 FDX or ESD DOCSIS. The client device 102 may be configured to transmit upstream signals to the network node 108 via one or more upstream frequency bands of the communication medium 110. The client device 102 may be configured to receive downstream signals from the network node 108 via one or more downstream frequency bands of the communication medium 110.

If the client device 102 is a DOCSIS 4.0 cable modem, the client device 102 may be configured to transmit upstream signals to the network node 108 across N parallel channels simultaneously in the 108 to 684 megahertz (MHZ) band in either the Full Duplex DOCSIS (FDX) or Frequency Division Duplex (FDD) mode of operation. The value of N may range from one to six upstream channels. Each upstream channel may occupy a bandwidth of 96 MHz. A minimum of two active channels may be required, as the transmit power and corresponding receive level of each channel may be chosen differently for the optimization of capacity.

The transmitted signal power over the i^{th} channel may herein be denoted as sᵢ, the received signal power over that channel may herein be denoted as rᵢ, and the path gain (magnitude transfer function) between the transmitting client device 102 and the receiving network node 108 may herein be denoted as gᵢ. The path gain may mainly comprise the loss from the client device 102 through the tap port and across the taps in the span to the first amplifier in the upstream path. After reaching the first amplifier, unity gain in a properly configured plant may preserve the delivered signal level but add noise through the amplifier cascade. Noise power may be added in each channel. The noise power added in each channel may herein be denoted as Nᵢ.

Each path gain gᵢ may be calculated by subtracting the client device 102 reported upstream transmit level after ranging from the measured client device 102 upstream receive level at the port of the network node 108. Alternatively, each path gain gᵢ may be calculated by subtracting the network node 108 reported (or extrapolated for ESD) downstream transmit level from the measured downstream receive level at the client device 102. For an FDX node with echo cancellation (EC) of the downstream echo from the upstream signal in the FDX band (e.g., 108 to 684 MHZ), the network node 108 post-EC residual level and signal-to-noise ratio (SNR) may be measured when no user devices (e.g., no cable modems) are granted transmission opportunities. The upstream receiver modulation error ratio (MER) using the minislot pilot tones may be measured for a client device 102 grant of a known channel transmit level. The input noise level Nᵢ to the network node 108 may then be calculated at the network node 108. The received MER for each channel may be available from the OFDMA demodulator which provides the received SNR for each upstream channel. These parameters may be used to determine the optimum individual upstream channel transmit levels to maximize capacity (e.g., bitrate) summed across the entire set of upstream OFDMA channels.

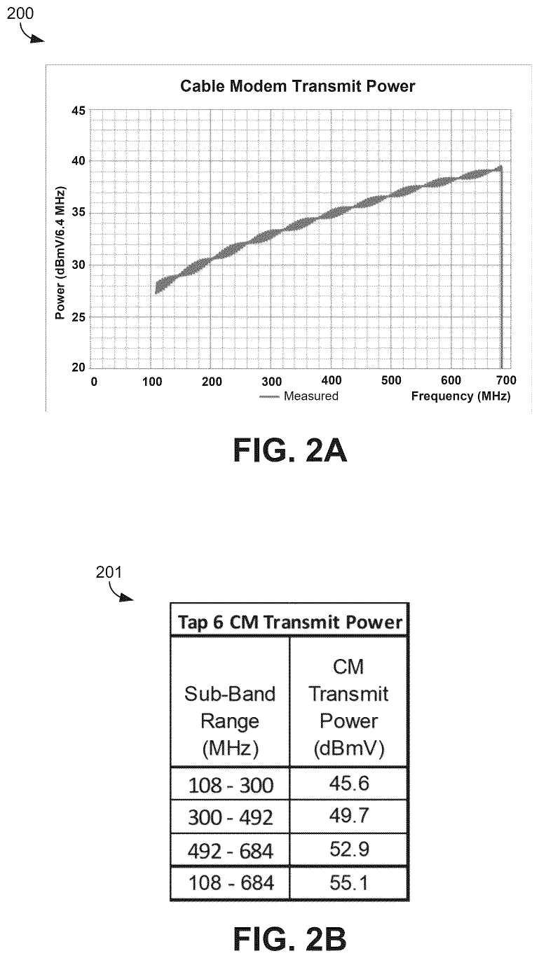

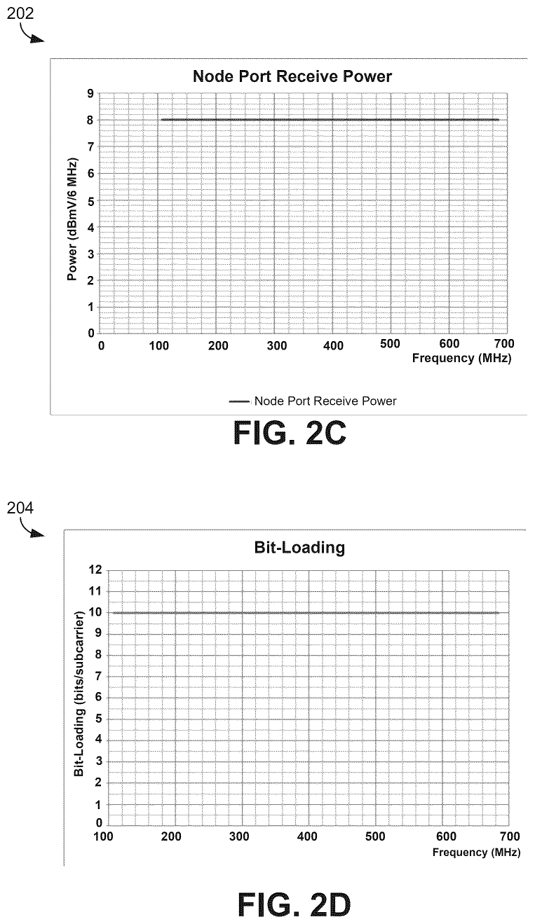

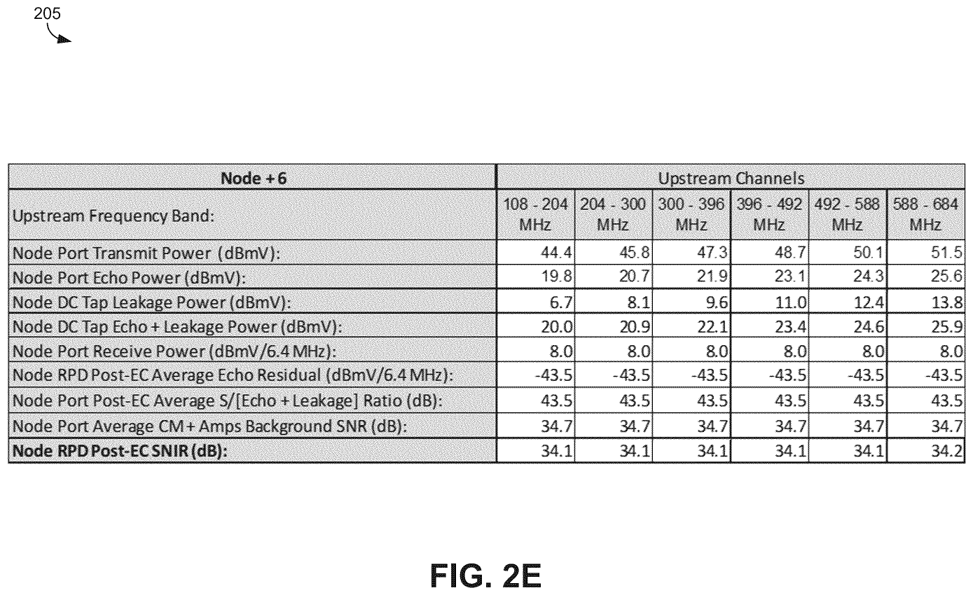

The upstream transmit levels of the client device 102 may be set to cause a constant receive power versus frequency at the network node 108. FIG. 2A shows a graph 200. The graph 200 indicates the upstream transmit power versus frequency of the client device 102 (in units of dBmV/6.4 MHZ) across a plurality of upstream channels to achieve a constant receive power versus frequency at the network node 108 if the client device 102 has a total upstream transmit power of 55 dBmV. For example, the graph 200 indicates the upstream transmit power versus frequency of the client device 102 (in units of dBmV/6.4 MHz) across six 96 MHz upstream channels in the 108 to 684 MHz frequency band to achieve a constant receive power versus frequency of eight dBmV/6.4 MHz at the network node 108. FIG. 2B shows a table 201. The table 201 depicts the average upstream transmit power of the client device 102 (in units of dBmV) across the plurality of upstream channels to achieve the constant receive power versus frequency of eight dBmV/6.4 MHz at the network node 108 if the client device 102 has a total upstream transmit power of 55 dBmV.

FIG. 2C shows a graph 202 indicating that the constant receive power versus frequency of 8 dBmV/6.4 MHz is achieved at the network node 108 if the 55 dBmV total transmit power of the client device 102 is allocated across the plurality of channels in the manner shown in FIGS. 2A-2B. FIG. 2D shows a graph 204. The graph 204 indicates an average bit-loading (in units of bits/subcarrier) across the plurality of channels if a constant receive power versus frequency of eight dBmV/6.4 MHz is achieved at the network node 108. For example, the graph 204 indicates that an average bit-loading of ten bits/subcarrier across the plurality of channels is achieved if a constant receive power versus frequency of eight dBmV/6.4 MHz and a 34 dB received MER as shown in table 105 of FIG. 2E is achieved at the network node 108. If the average bit-loading across the plurality of channels is equal to ten bits/subcarrier, this may indicate that a total upstream capacity associated with the plurality of channels is equal to approximately 5,760 megabits per second (Mbps).

FIG. 2E shows a table 205. The table 205 indicates the network node 108 port transmit and receive signal levels, echo interference levels, network node 108 signal to interference ratio (SIR), amplifier cascade SNR, and the combined network node 108 Signal-to-interference-plus-noise ratio (SNIR) if the 55 dBmV total transmit power of the client device 102 is allocated across the plurality of channels in the manner shown in FIGS. 2A-2B. As shown in the table 205, each of the plurality of upstream channels is associated with approximately the same SNIR at the network node 108. For example, an SNIR of 34.1 to 34.2 dB is achieved at the network node 108 across each of the plurality of upstream channels.

As described above, DOCSIS 4.0 technology may provide a significant increase in the available spectrum, especially for the traffic transmitted upstream from the client device 102 back to the network node 108 via the plurality of upstream channels. However, if the upstream transmit levels of the client device 102 is set to achieve a constant receive power versus frequency of eight dBmV/6.4 MHz at the network node 108, the increase in available upstream spectrum may be underutilized (e.g., the full potential increase in capacity may not be achieved). For example, the total upstream capacity of approximately 5,760 Mbps may be less than the total potential upstream capacity.

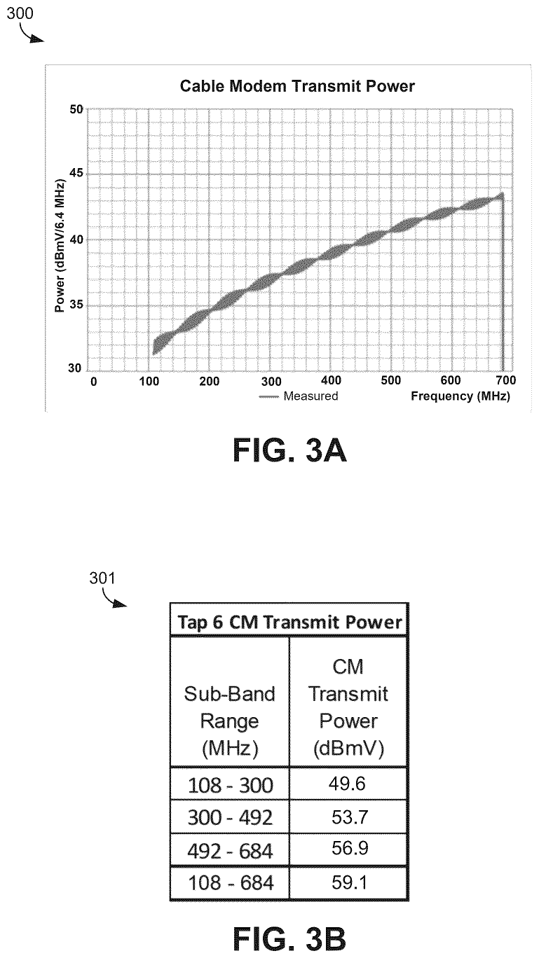

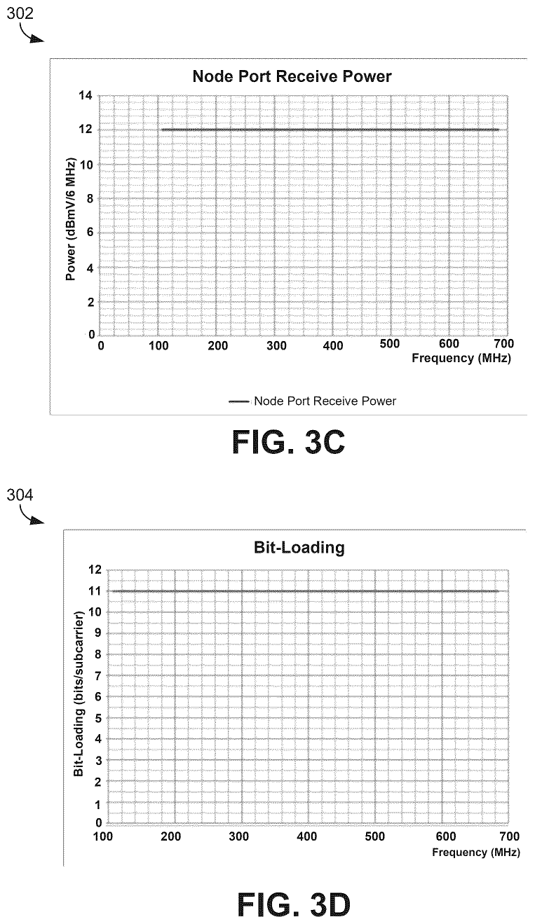

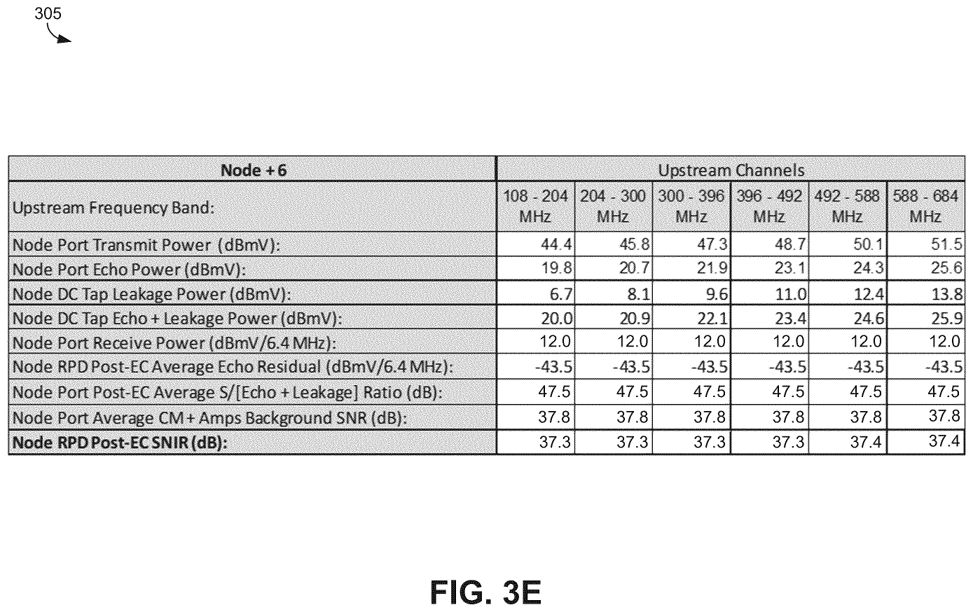

FIG. 3A shows a graph 300. The graph 300 indicates the upstream transmit power versus frequency of the client device 102 (in units of dBm V/6.4 MHZ) across a plurality of upstream channels to achieve a constant receive power versus frequency at the network node 108 if the client device 102 has a total upstream transmit power of 59 dBmV. For example, the graph 300 indicates the upstream transmit power versus frequency of the client device 102 (in units of dBmV/6.4 MHZ) across six 96 MHz upstream channels in the 108 to 684 MHz frequency band to achieve a constant receive power versus frequency of twelve dBmV/6.4 MHz at the network node 108. FIG. 3B shows a table 301. The table 301 depicts the average upstream transmit power of the client device 102 (in units of dBmV) across the plurality of upstream channels to achieve the constant receive power versus frequency of twelve dBmV/6.4 MHz at the network node 108 if the client device 102 has a total upstream transmit power of 59 dBmV.

FIG. 3C shows a graph 302 indicating that the constant receive power versus frequency of twelve dBmV/6.4 MHz is achieved at the network node 108 if the 59 dBmV total transmit power of the client device 102 is allocated across the plurality of channels in the manner shown in FIGS. 3A-3B. FIG. 3D shows a graph 304. The graph 304 indicates an average bit-loading (in units of bits/subcarrier) across the plurality of channels if a constant receive power versus frequency of twelve dBmV/6.4 MHz is achieved at the network node 108. For example, the graph 304 indicates that an average bit-loading of eleven bits/subcarrier across the plurality of channels is achieved if a constant receive power versus frequency of twelve dBmV/6.4 MHz and a 37 dB received MER as shown in table 305 of FIG. 3E is achieved at the network node 108. If the average bit-loading across the plurality of channels is equal to eleven bits/subcarrier, this may indicate that a total upstream capacity associated with the plurality of channels is equal to approximately 6,336 megabits per second (Mbps).

FIG. 3E shows a table 305. The table 305 indicates the network node 108 port transmit and receive signal levels, echo interference levels, network node 108 signal to interference ratio (SIR), amplifier cascade SNR, and the combined network node 108 SNIR if the 59 dBmV total transmit power of the client device 102 is allocated across the plurality of channels in the manner shown in FIGS. 3A-3B. As shown in the table 305, each of the plurality of upstream channels is associated with approximately the same SNIR at the network node 108. For example, an SNIR of 37.3 to 37.4 dB is achieved at the network node 108 across each of the plurality of upstream channels.

As described above, DOCSIS 4.0 technology may provide a significant increase in the available spectrum, especially for the traffic transmitted upstream from the client device 102 back to the network node 108 via the plurality of upstream channels. However, if the upstream transmit levels of the client device 102 is set to achieve a constant receive power versus frequency of twelve dBmV/6.4 MHz at the network node 108, the increase in available upstream spectrum may be underutilized (e.g., the full potential increase in capacity may not be achieved). For example, the total upstream capacity of approximately 6,336 Mbps may be less than the total potential upstream capacity.

OFDM is a digital modulation scheme that transmits data by splitting it into multiple parallel subcarriers, each modulated with a lower data rate. Instead of sending data on a single high-speed carrier, OFDM divides the data stream into multiple, slower subcarriers. These subcarriers may be carefully spaced so that they are orthogonal to each other (e.g., they do not interfere with each other, even though they overlap in the frequency spectrum). Each subcarrier may then be modulated using a technique like QAM (Quadrature Amplitude Modulation). Higher-order OFDM modulations (e.g., 64-QAM, 256-QAM) may pack more bits per symbol, but may be more susceptible to noise, requiring a higher threshold SNR for reliable communication.

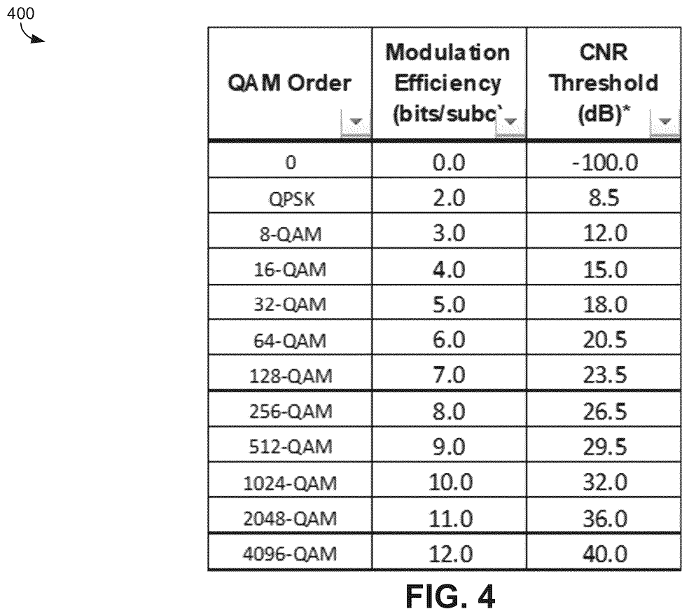

FIG. 4 shows an example table 400. The table 400 indicates the SNIR thresholds for error-free reception for various QAM levels. In the table 400, the SNIR thresholds for error-free reception for various QAM levels are denoted as “CNR.” The modulation order and efficiency (e.g., bit-loading) for the QAM levels are associated with these minimum CNR thresholds. Referring back to the example of FIGS. 2A-E, the SNIR for each of the plurality of upstream channels if the client device 102 has a total upstream transmit power of 55 dBmV may be approximately equal to 34 dB. As shown in the table 400, 34 dB is between the CNR threshold for the 1024-QAM and 2048-QAM modulation order. Thus, a lower threshold just below the 34 dB CNR may be conservatively chosen with the bit-loading for 1024-QAM or ten bits/symbol (as shown in FIG. 2D). Referring back to the example of FIGS. 3A-E, the SNIR for each of the plurality of upstream channels if the client device 102 has a total upstream transmit power of 59 dBmV may be approximately equal to 37 dB. As shown in the table 400, 37 dB is between the CNR threshold for the 2048-QAM and 4096-QAM modulation order. Thus, a lower threshold just below the 37 dB CNR may be conservatively chosen with the bit-loading for 2048-QAM or eleven bits/symbol (as shown in FIG. 3D).

Referring back to FIG. 1, if the upstream transmit levels of the client device 102 are set to cause a constant receive power versus frequency at the network node 108 (e.g., as discussed above with regard to FIGS. 2A-E and FIGS. 3A-E), the increase in available upstream spectrum provided by the DOCSIS 4.0 specification may be underutilized (e.g., the full potential increase in capacity may not be achieved). To better utilize the increase in available upstream spectrum for the client device 102, a water-filling algorithm, such as a conventional water-filling algorithm or a geometric water-filling algorithm, may be used to allocate the total upstream transmit power associated with the client device 102 across the plurality of upstream channels. For example, the total upstream transmit power associated with the client device 102 may be allocated, based on the water-filling algorithm, by the server device 120, by the client device 102, and/or by any other suitable device. Allocating the total upstream transmit power associated with the client device 102 across the plurality of upstream channels may comprise determining, based on a water-filling algorithm, a separate transmit power for each of the plurality of upstream channels used to transmit upstream signals from the client device 102 to the network node 108. Determining, based on the water-filling algorithm, the separate transmit power for each of the plurality of upstream channels may comprise determining, for each of the plurality of upstream channels with a constant noise level, a transmit power level that is inversely proportional to an amount of path loss associated with the channel.

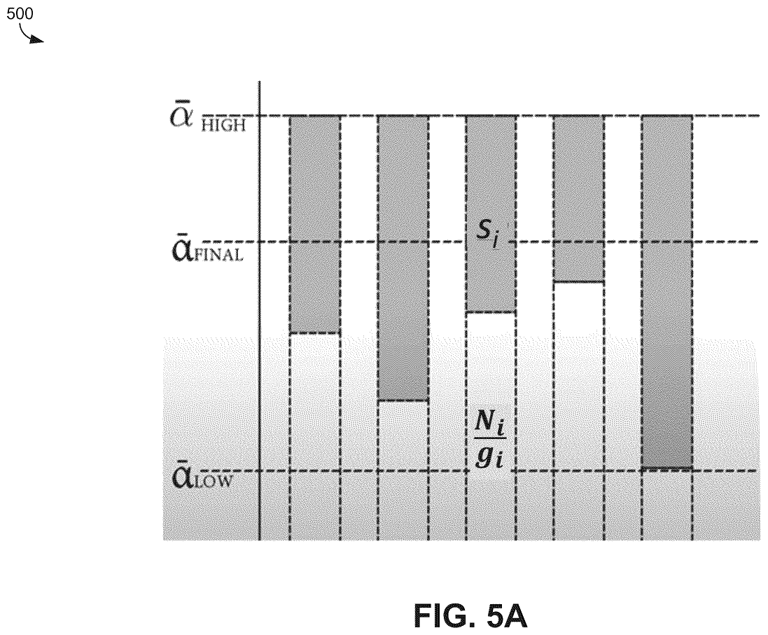

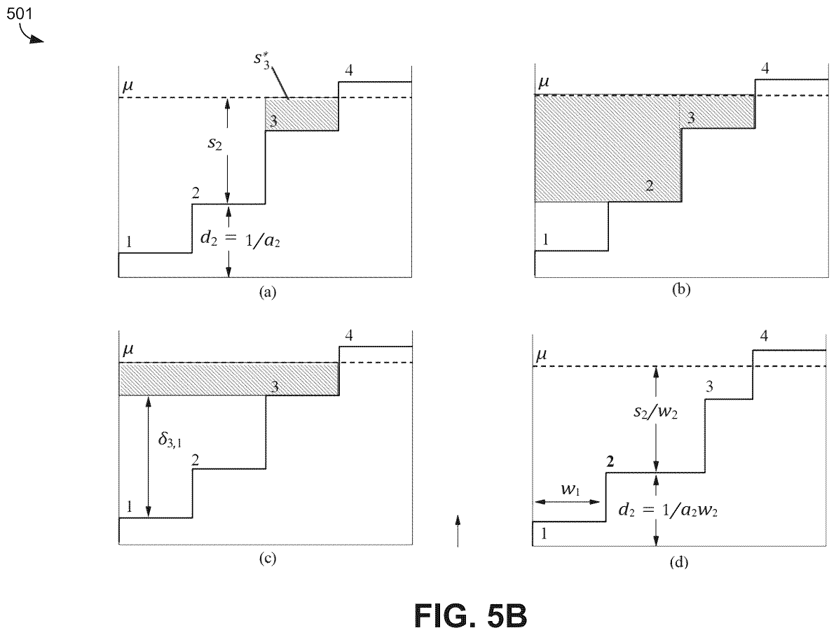

Referring to the example chart 500 shown in FIG. 5A, the maximum throughput rate of the i^{th} channel may be given by the Shannon channel capacity Cᵢ in channel bandwidth wᵢ as:

$${C}_{i} = {w}_{i} {log}_{2} ( 1 + {SNR}_{i} ) = {w}_{i} {log}_{2} ( 1 + \frac{{g}_{i} {s}_{ι}}{{N}_{i}} ) ,$$

where the i^{th} channel received

$${SNR}_{i} = \frac{{g}_{i} {s}_{i}}{{N}_{i}} .$$

The total throughput may be found by the sum of rates over all N channels as

$${\sum }_{i = 1}^{n} {w}_{i} {log}_{2} ( 1 + \frac{{g}_{i} {s}_{i}}{{N}_{i}} ) .$$

The available transmit power P (e.g., 55 dBmV or 59 dBmV) may be constrained by the sum of all channel powers sᵢ as:

$${\sum }_{i = 1}^{n} {s}_{i} = P .$$

The optimal power loading per channel may be found by solving the following sum rate maximization:

$$maximize {\sum }_{i = 1}^{n} {w}_{i} {log}_{2} ( 1 + \frac{{g}_{i} {s}_{i}}{{N}_{i}} ) over {s}_{i} ,$$

$$such that$$

$${\sum }_{i = 1}^{n} {s}_{i} = P ,$$

$$where$$

$${s}_{i} \geq 0 ∀ i .$$

The solution to this sum rate maximization (e.g., the sum rate maximization that is solved for the transmit powers sᵢ) may be found by a Lagrange multiplier method. This solution may be referred to as “water-filling.”

The Lagrangian [symbol] for the sum rate maximization objective with constraints may be

$$ℒ ( s , λ , {λ}_{0} ) = - {\sum }_{i = {1}^{W} i}^{n} {log}_{2} ( 1 + \frac{{g}_{i} {s}_{i}}{{N}_{i}} ) + {λ}_{0} ( {\sum }_{i = 1}^{n} {s}_{i} - P ) - {\sum }_{i = 1}^{n} {λ}_{i} {s}_{i} .$$

found by setting the gradient of the Lagrangian with respect to the power variables sᵢ equal to zero, solving for the transmit power levels sᵢ, and applying the Karush-Kuhn-Tucker (KKT) conditions of complementary slackness to remove the slack variables {λ₁, . . . , λₙ}. The result may be

$${s}_{i} = {[ \frac{1}{{λ}_{0}} - \frac{{N}_{i}}{{g}_{i}} ]}^{+} = max ( \frac{1}{{λ}_{0}} - \frac{{N}_{i}}{{g}_{i}} , 0 ) ,$$

where [ ]⁺ disallows negative power values. Let

$$α = \frac{1}{{λ}_{0}} ,$$

$$so that$$

$${s}_{i} = {[ α - \frac{{N}_{i}}{{g}_{i}} ]}^{+} .$$

α may be compared to a “water-filling” power level, whereby all sᵢ can be found as the difference between this water-filling level α and the inverse of the channel gain divided by the channel noise level

$$\frac{{N}_{i}}{{g}_{i}} .$$

For example, the power may be represented by water being poured into a tank with different depths in the bottom representing the inverse channel gain divided by noise level. The water level rises above all or most of the different bottom depths as shown in FIG. 5A.

The water-filling level α may be implicitly specified and may be found by iteratively checking if the sum of the calculated transmit power levels sᵢ is equal to the maximum total power constraint P. This may be an implicit solution as the water-filling level α may be found subject to the maximum power constraint

$${\sum }_{i = 1}^{n} {s}_{i} = P$$

using all iterative procedure, such as a bisection search for the value of a that meets this constraint. This procedure for solving the non-linear system for the water level may be referred to as a Conventional Water-Filling (CWF) Algorithm. In theory an infinite number of bisection calculations may converge on the exact water level, but a tolerable error ε→0 can limit the number of iterations. Some possible bounds α_{Low} and α_{High} for the start of a bisection search for a are as follows:

| Initialize: | |
|---|---|
| ${α}_{L o w} = min ( \frac{{N}_{i}}{{g}_{i}} ) ,$ | i = 1, ... , n (lowest active channel) |
| ${α}_{H i g h} = \frac{P + {\sum }_{i = 1}^{n} \frac{{N}_{i}}{{g}_{i}}}{n}$ | (all channels active) |

Iterative search:
1) α_{Next} = (α_{Low} + α_{High})/2
2) Calculate sᵢ with α_{Next}
$3 ) Calculate {\sum }_{i = 1}^{n} {s}_{i} = {P}^{′}$
4) If P′ > P then α_{High} = α_{Next}, else α_{Low} = α_{Next}
$5 ) If \vert {P}^{′} - P \vert < ε then STOP and output {\{ {s}_{i} \}}_{i = 1}^{n} , else go to 1.$

Instead of using CWF algorithm described with regard to FIG. 5A to allocating the total upstream transmit power associated with the client device 102 across the plurality of upstream channels, a Geometric Water-Filling (GWF) may instead be used. The GWF approach may provide an explicit solution for the sum rate maximization described above (e.g., sum rate maximization: maximize

$${\sum }_{i = 1}^{n} {w}_{i} {log}_{2} ( 1 + \frac{{g}_{i} {s}_{i}}{{N}_{i}} )$$

over sᵢ, such that

$${\sum }_{i = 1}^{n} {s}_{i} = P ,$$

where s_{i≥0} ∀i), eliminating the procedure to solve the non-linear system for the water level. [ ]

The graphs 501 shown in FIG. 5B illustrates the GWF algorithm. Suppose there are four steps/stairs (N=4) with unit width inside a water tank. For the CWF, the dashed horizontal line, which is the water level α, may need to be determined first, and then the power allocated for each stair (water volume above the stair) may be solved. Let dᵢ denote the “step depth” of the i^{th} stair which is the height of the i^{th} step to the bottom of the tank, and is given by

$${d}_{i} = \frac{1}{{a}_{i} {w}_{i}} where {a}_{i} = \frac{{g}_{i}}{{N}_{i}} ,$$

i=1, . . . , n. The sequence αᵢ may be sorted as monotonically decreasing, then the step depth of the stairs indexed as {1, . . . , n} may be monotonically increasing. Define δᵢⱼ as the “step depth difference” of the i^{th} and the j^{th} stairs expressed as

$${δ}_{i j} = {d}_{i} - {d}_{j} = \frac{1}{{a}_{i} {w}_{i}} - \frac{1}{{a}_{j} {w}_{j}} ,$$

i≥j and 1≤i,j≤n.

Instead of trying to determine the water level α, which is a real non-negative number, the water level step may be determined. The water level step may be an integer number from 1 to N, denoted by k*, as the highest step under water. Based on the result of k*, the solutions for power allocation may be determined explicitly without the knowledge of the water level α. P₂(k) may denote the water volume above step k or zero, whichever is greater. The value of P₂(k) may be solved by subtracting the volume of the water under step k from the total power P, as

$${P}_{2} ( k ) = P - {[ {\sum }_{i = 1}^{k - 1} ( {d}_{k} - {d}_{i} ) {w}_{i} ]}^{+} ,$$

k=1, . . . , n. Due to the definition of P₂(k) being the power (water volume) above step k, it cannot be a negative number (e.g., negative power). As such, the use of [ ]⁺ in P₂(k) may assigns 0 to P₂(k) if the result inside the bracket is negative. The corresponding geometric meaning may be that the k^{th} level is above water. The explicit solution to the sum rate maximization may be given be:

$${s}_{i} = \{ \begin{matrix}[ \frac{{s}_{{k}^{*}}}{{w}_{{k}^{*}}} + ( {d}_{{k}^{*}} - {d}_{i} ) ] {w}_{i} , 1 \leq i \leq {k}^{*} \\ \begin{matrix}0 , & {k}^{*} < i \leq n\end{matrix}\end{matrix}$$

where the water level step k* may be given as k*=max {k|P₂(k)>0}, 1≤k≤n and the power level for this step may be

$${s}_{{k}^{*}} = \frac{{w}_{{k}^{*}}}{{\sum }_{i = 1}^{{k}^{*}} {w}_{i}} {P}_{2} ( {k}^{*} ) .$$

The upstream transmit levels of the client device 102 may be set based on the transmit levels determined using the water-filling algorithm (e.g., the conventional water-filing algorithm described above with regard to FIG. 5A or the geometric water-filling algorithm described above with regard to FIG. 5B).

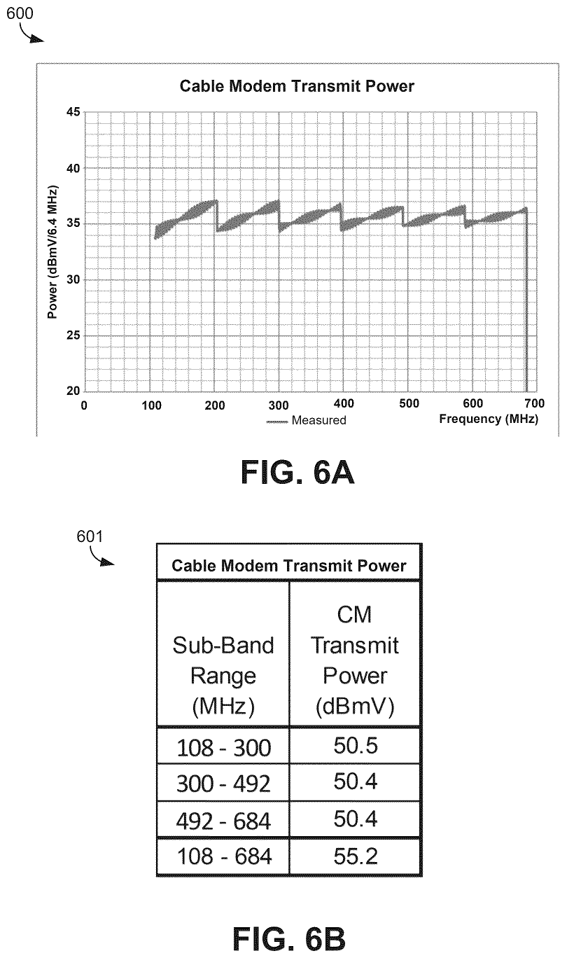

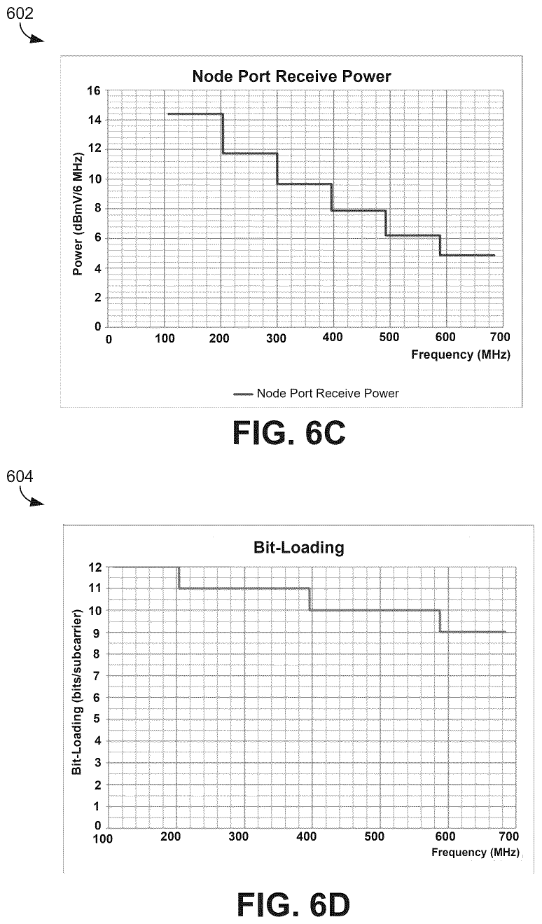

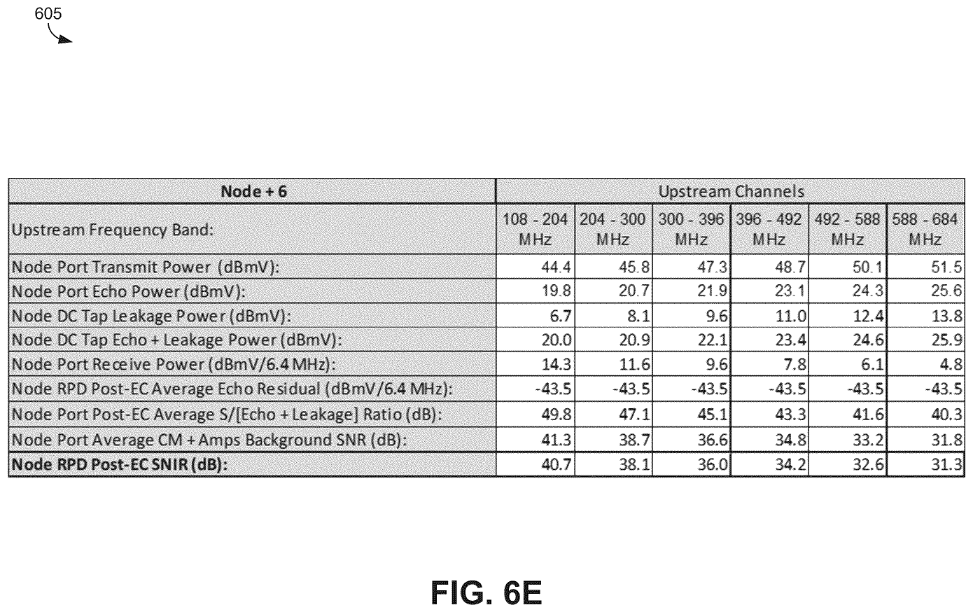

FIG. 6A shows a graph 600. The graph 600 indicates the upstream transmit power versus frequency of the client device 102 (in units of dBmV/6.4 MHZ) across a plurality of upstream channels if the client device 102 has a total upstream transmit power of 55 dBmV, and if the upstream transmit levels of the client device 102 are set based on the transmit levels determined using the water-filling algorithm. For example, the graph 600 indicates the upstream transmit power versus frequency of the client device 102 (in units of dBmV/6.4 MHZ) across six 96 MHz upstream channels in the 108 to 684 MHz frequency band if the client device 102 has a total upstream transmit power of 55 dBmV, and if the upstream transmit levels of the client device 102 are set based on the transmit levels determined using the water-filling algorithm. FIG. 6B shows a table 601. The table 601 depicts the average upstream transmit power of the client device 102 (in units of dBmV) across the plurality of upstream channels if the client device 102 has a total upstream transmit power of 55 dBmV, and if the upstream transmit levels of the client device 102 are set based on the transmit levels determined using the water-filling algorithm.

FIG. 6C shows a graph 602 indicating that a non-constant receive power versus frequency is achieved at the network node 108 if the 55 dBmV total transmit power of the client device 102 is allocated across the plurality of channels in the manner shown in FIGS. 6A-6B. FIG. 6D shows a graph 604. The graph 604 indicates an average bit-loading (in units of bits/subcarrier) across the plurality of channels if the non-constant receive power versus frequency shown in FIG. 6C is achieved at the network node 108. For example, the graph 604 indicates that an average bit-loading of 10.5 bits/subcarrier across the plurality of channels is achieved if the non-constant receive power versus frequency shown in FIG. 6C is achieved at the network node 108.

If the average bit-loading across the plurality of channels is equal to 10.5 bits/subcarrier, this may indicate that a total upstream capacity associated with the plurality of channels is equal to approximately 6,049 Mbps. Notably, this is higher than the total upstream capacity described above with regard to FIG. 2D (which is 5,760 Mbps), showing that allocating the transmit power based on the water-filling algorithm may enable an increased utilization of the available upstream spectrum for the client device 102. In other words, allocating the transmit power based on the water-filling algorithm may increase capacity of the client device 102 over the uniform network node 108 receive level of FIGS. 2A-E, yielding an increase of 0.5 bit/symbol average across the six upstream channel with a resultant 5 percent (6049/5760) increase in bitrate.

FIG. 6E shows a table 605. The table 605 indicates the network node 108 port transmit and receive signal levels, echo interference levels, network node 108 signal to interference ratio (SIR), amplifier cascade SNR, and the combined network node 108 SNIR if the 55 dBmV total transmit power of the client device 102 is allocated across the plurality of channels in the manner shown in FIGS. 6A-6B. As shown in the table 605, each of the plurality of upstream channels is now associated with a different SNIR at the network node 108. Several of the SNIR values in the bottom row of the table 605 are above the CNR thresholds for the modulation orders shown in the table 400 of FIG. 4. Several of the SNIR values in the bottom row of the table 605 are nearly equal to the closest CNR threshold for the modulation orders shown in the table 400 of FIG. 4.

For example, the upstream channel in the 108 to 204 MHz frequency band is associated with a 40.7 dB SNIR at the network node 108. As shown in the table 400, 40.7 dB is above the CNR threshold for the 4096-QAM modulation order. The upstream channel in the 204 to 300 MHz frequency band is associated with a 38.1 dB SNIR at the network node 108. As shown in the table 400, 38.1 dB is between the CNR threshold for the 2048-QAM and 4096-QAM modulation order. Thus, a lower threshold just below the 38.1 dB CNR may be conservatively chosen with the bit-loading for 2048-QAM or eleven bits/symbol. The upstream channel in the 300 to 396 MHz frequency band is associated with a 36 dB SNIR at the network node 108. As shown in the table 400, 36 dB is the CNR threshold for the 2048-QAM modulation order. The upstream channel in the 396 to 492 MHz frequency band is associated with a 34.2 dB SNIR at the network node 108. As shown in the table 400, 34.2 dB is between the CNR threshold for the 1024-QAM and the 2048-QAM modulation order. Thus, a lower threshold just below the 34.2 dB CNR may be conservatively chosen with the bit-loading for 1024-QAM or ten bits/symbol. The upstream channel in the 492 to 588 MHZ frequency band is associated with a 32.6 dB SNIR at the network node 108. As shown in the table 400, 32.6 dB is between the CNR threshold for the 1024-QAM and the 2048-QAM modulation order. Thus, a lower threshold just below the 32.6 dB CNR may be conservatively chosen with the bit-loading for 1024-QAM or ten bits/symbol. Finally, the upstream channel in the 588-684 MHz frequency band is associated with a 31.3 dB SNIR at the network node 108. As shown in the table 400, 31.3 dB is between the CNR threshold for the 512-QAM and 1024-QAM modulation order. Thus, a lower threshold just below the 31.3 dB CNR may be conservatively chosen with the bit-loading for 512-QAM or nine bits/symbol.

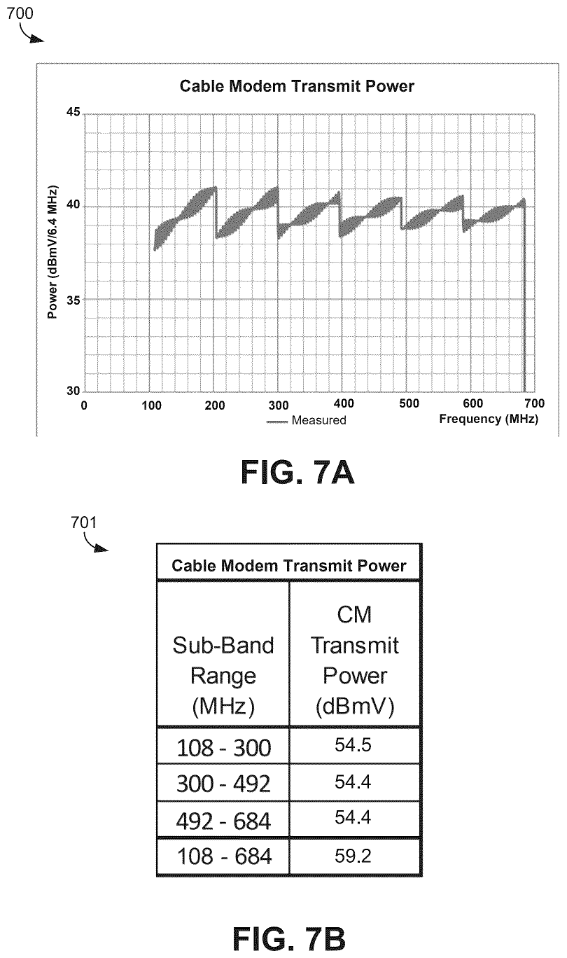

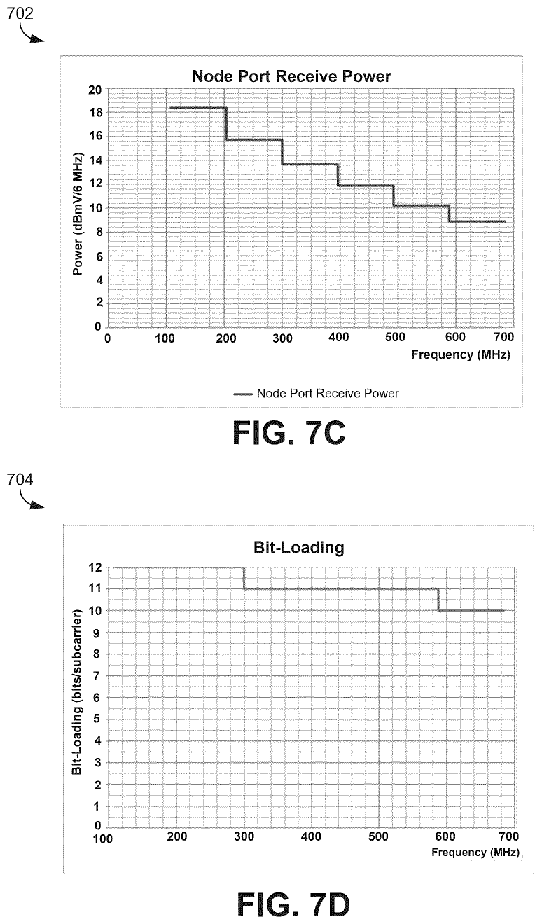

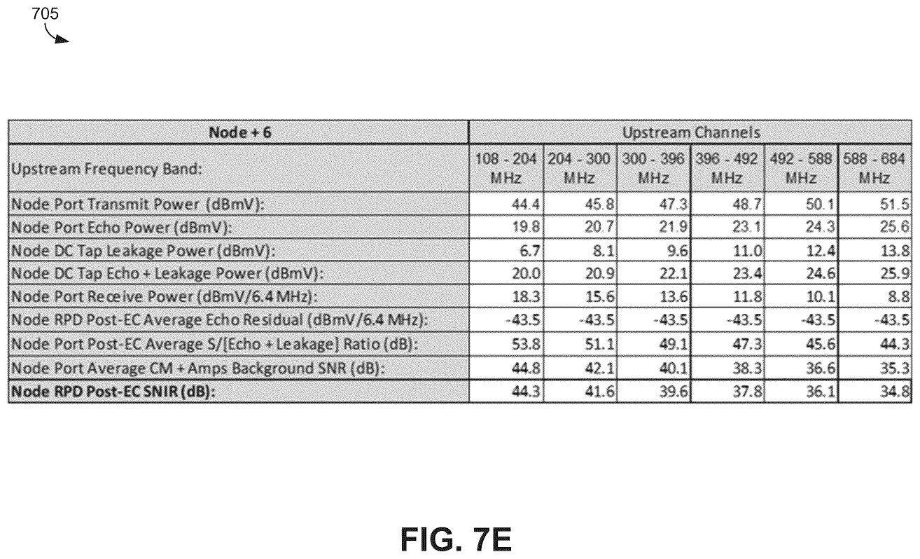

FIG. 7A shows a graph 700. The graph 700 indicates the upstream transmit power versus frequency of the client device 102 (in units of dBmV/6.4 MHZ) across a plurality of upstream channels if the client device 102 has a total upstream transmit power of 59 dBmV, and if the upstream transmit levels of the client device 102 are set based on the transmit levels determined using the water-filling algorithm. For example, the graph 700 indicates the upstream transmit power versus frequency of the client device 102 (in units of dBmV/6.4 MHZ) across six 96 MHz upstream channels in the 108 to 684 MHz frequency band if the client device 102 has a total upstream transmit power of 59 dBmV, and if the upstream transmit levels of the client device 102 are set based on the transmit levels determined using the water-filling algorithm. FIG. 7B shows a table 701. The table 701 depicts the average upstream transmit power of the client device 102 (in units of dBmV) across the plurality of upstream channels if the client device 102 has a total upstream transmit power of 59 dBmV, and if the upstream transmit levels of the client device 102 are set based on the transmit levels determined using the water-filling algorithm. For high SNR channels, standard water-filling allocates equal transmission power per channel which increases the maximum sum rate capacity but may not be optimum due to the individual channel received SNR values being above the threshold value for a given channel bitloading.

FIG. 7C shows a graph 702 indicating that a non-constant receive power versus frequency is achieved at the network node 108 if the 59 dBmV total transmit power of the client device 102 is allocated across the plurality of channels in the manner shown in FIGS. 7A-7B. FIG. 7D shows a graph 704. The graph 704 indicates an average bit-loading (in units of bits/subcarrier) across the plurality of channels if the non-constant receive power versus frequency shown in FIG. 7C is achieved at the network node 108. For example, the graph 704 indicates that an average bit-loading of 11.2 bits/subcarrier across the plurality of channels is achieved if the non-constant receive power versus frequency shown in FIG. 7C is achieved at the network node 108.

If the average bit-loading across the plurality of channels is equal to 10.5 bits/subcarrier, this may indicate that a total upstream capacity associated with the plurality of channels is equal to approximately 6,432 Mbps. Notably, this is higher than the total upstream capacity described above with regard to FIG. 3D (which is 6,336 Mbps), showing that allocating the transmit power based on the water-filling algorithm may enable an increased utilization of the available upstream spectrum for the client device 102. In other words, allocating the transmit power based on the water-filling algorithm may increase capacity of the client device 102 over the uniform network node 108 receive level of FIGS. 3A-E, yielding an increase of 0.2 bit/symbol average across the six upstream channels with a resultant 1.5 percent (6432/6336) increase in bitrate.

FIG. 7E shows a table 705. The table 705 indicates the network node 108 port transmit and receive signal levels, echo interference levels, network node 108 signal to interference ratio (SIR), amplifier cascade SNR, and the combined network node 108 SNIR if the 59 dBmV total transmit power of the client device 102 is allocated across the plurality of channels in the manner shown in FIGS. 7A-7B. As shown in the table 705, each of the plurality of upstream channels is now associated with a different SNIR at the network node 108. Several of the SNIR values in the bottom row of the table 705 are above the CNR thresholds for the modulation orders shown in the table 400 of FIG. 4. Several of the SNIR values in the bottom row of the table 705 are nearly equal to the closest CNR threshold for the modulation orders shown in the table 400 of FIG. 4.

For example, the upstream channel in the 108 to 204 MHz frequency band is associated with a 44.3 dB SNIR at the network node 108. As shown in the table 400, 44.3 dB is above the CNR threshold for the 4096-QAM modulation order. The upstream channel in the 204 to 300 MHz frequency band is associated with a 41.6 dB SNIR at the network node 108. As shown in the table 400, 41.6 dB is above the CNR threshold for the 4096-QAM modulation order. The upstream channel in the 300 to 396 MHz frequency band is associated with a 39.6 dB SNIR at the network node 108. As shown in the table 400, 39.6 dB is between the CNR threshold for the 2048-QAM and the 4096-QAM modulation order. Thus, a lower threshold just below the 39.6 dB CNR may be conservatively chosen with the bit-loading for 2048-QAM or eleven bits/symbol. The upstream channel in the 396 to 492 MHz frequency band is associated with a 37.8 dB SNIR at the network node 108. As shown in the table 400, 37.8 dB is between the CNR threshold for the 2048-QAM and the 4096-QAM modulation order. Thus, a lower threshold just below the 37.8 dB CNR may be conservatively chosen with the bit-loading for 2048-QAM or eleven bits/symbol. The upstream channel in the 492 to 588 MHz frequency band is associated with a 36.1 dB SNIR at the network node 108. As shown in the table 400, 36.1 dB is between the CNR threshold for the 2048-QAM and the 4096-QAM modulation order. Thus, a lower threshold just below the 36.1 dB CNR may be conservatively chosen with the bit-loading for 2048-QAM or eleven bits/symbol. Finally, the upstream channel in the 588-684 MHz frequency band is associated with a 34.8 dB SNIR at the network node 108. As shown in the table 400, 34.8 dB is between the CNR threshold for the 1024-QAM and 2048-QAM modulation order. Thus, a lower threshold just below the 34.8 dB CNR may be conservatively chosen with the bit-loading for 1024-QAM or ten bits/symbol.

As described above, the transmit power allocation determined based on a water-filling algorithm may enable an increased utilization of the available upstream spectrum for the client device 102. However, the available upstream spectrum may still be underutilized (e.g., the full potential increase in capacity may still not be achieved). For example, if the client device 102 is associated with 55 dBmV of total transmit power, and if the 55 dBmV total transmit power is allocated across the plurality of channels using a water-filling algorithm (as discussed above with regard to FIGS. 6A-6E), the total upstream capacity associated with the plurality of channels may be equal to approximately 6,049 Mbps. While this is an increase in total upstream capacity as compared to the total upstream capacity associated with the plurality of channels if the 55 dBmV total transmit power is allocated across the plurality of channels so to achieve a constant receive power versus frequency at the network node 108 (as discussed above with regard to FIGS. 2A-2E), an even higher upstream capacity associated with the plurality of channels may potentially be achieved by modifying the transmit power allocation determined based on the water-filling algorithm based on individual peak power limits associated with each upstream channel.

As another example, if the client device 102 is associated with 59 dBmV of total transmit power, and if the 59 dBmV total transmit power is allocated across the plurality of channels using a water-filling algorithm (as discussed above with regard to FIGS. 7A-7E), the total upstream capacity associated with the plurality of channels may be equal to approximately 6,432 Mbps. While this is an increase in total upstream capacity as compared to the total upstream capacity associated with the plurality of channels if the 59 dBmV total transmit power is allocated across the plurality of channels so to achieve a constant receive power versus frequency at the network node 108 (as discussed above with regard to FIGS. 3A-3E), an even higher upstream capacity associated with the plurality of channels may potentially be achieved by modifying the transmit power allocation determined based on the water-filling algorithm based on individual peak power limits associated with each upstream channel.

The transmit power allocation determined based on the water-filling algorithm may be modified based on (e.g., in response to) determining that the individual transmit power determined, based on the water-filling algorithm, for at least one channel of the plurality of channels exceeds an amount of transmit power required to achieve a first SNR threshold associated with the at least one channel at the network node 108. The first SNR threshold may comprise a SNR that is required for the network node 108 to receive a signal via the at least one channel at a first threshold modulation level (e.g., a threshold QAM level). The first SNR threshold may comprise any one of the CNR thresholds listed in the table 400 of FIG. 4. For example, the first SNR threshold may comprise 29.5 dB if the first threshold modulation level is 512-QAM, the first SNR threshold may comprise 32 dB if the first threshold modulation level is 1024-QAM, the first SNR threshold may comprise 36 dB if the first threshold modulation level is 2048-QAM, and so on. If the individual transmit power determined, based on the water-filling algorithm, for at least one channel of the plurality of channels exceeds an amount of transmit power required to achieve the first SNR threshold associated with the at least one channel at the network node 108, this may indicate that, even if a portion of the individual transmit power determined, based on the water-filling algorithm, for the at least one channel is re-allocated to at least one other channel of the plurality of channels, the signal sent to the network node 108 via the at least one channel may still be received at the network node 108 at the first threshold modulation level.

Modifying the transmit power allocation determined, based on the water-filling algorithm, may comprise re-allocating a portion of the individual transmit power determined, based on the water-filling algorithm, for the at least one channel to at least one other channel of the plurality of channels. It may be determined that the individual transmit power determined, based on the water-filling algorithm, for the at least one other channel is less than an amount of transmit power required to achieve a second threshold SNR associated with the at least one other channel at the network node 108. The second SNR threshold may comprise a SNR that is required for the network node 108 to receive a signal via the at least one other channel at a second threshold modulation level (e.g., a threshold QAM level). The second threshold SNR may be the same as the first SNR threshold (e.g., the second threshold modulation level may be the same as the first threshold modulation level). The second threshold SNR may be different than the first SNR threshold (e.g., the second threshold modulation level may different than the first threshold modulation level). Re-allocating the portion of the individual transmit power determined, based on the water-filling algorithm, for the at least one channel to the at least one other channel may increase an average bit-loading across the plurality of channels.

Modifying the transmit power allocation determined based on the water-filling algorithm may be based on individual peak power constraints associated with the plurality of upstream channels. The weighted water-filling with individual peak power constraints problem may be stated as follows: Given P>0, as the total power or volume of the water, the allocated power and the path gain for the i^{th} channel may be given as sᵢ and αᵢ respectively, i=1, . . . , n where n is the total number of transmit channels. The weights wᵢ>0 ∀i, and without loss of generality, the array elements of

$${\{ \frac{{g}_{i}}{{N}_{i}} {w}_{i} \}}_{i = 1}^{n}$$

may be positive and monotonically decreasing. The sum rate optimization with peak power per channel constraints may become

$${max}_{{\{ {s}_{i} \}}_{i = 1}^{n}} {\sum }_{i = 1}^{n} {w}_{i} {log}_{2} ( 1 + \frac{{g}_{i} {s}_{i}}{{N}_{i}} ) , subject to 0 \leq {s}_{i} \leq {P}_{i} , ∀ i , {\sum }_{i = 1}^{n} {s}_{i} \leq P .$$

Comparing the sum rate optimization with peak power per channel constraints to the sum rate maximization described above with regard to the water-filling algorithm

$$( maximize {\sum }_{i = 1}^{n} {w}_{i} {log}_{2} ( 1 + \frac{{g}_{i} {s}_{i}}{{N}_{i}} ) over {s}_{i} ,$$

such that, where sᵢ≥0 ∀i), the constraint of 0≤sᵢ may be extended to 0≤sᵢ≤Pᵢ, (e.g., additional individual peak power constraints), and

$${\sum }_{i = 1}^{n} {s}_{i} = P$$

equality may be extended to

$${\sum }_{i = 1}^{n} {s}_{i} \leq P$$

inequality. The sum rate optimization with peak power per channel constraints may thus be referred to as (weighted) water-filling with sum and individual peak power constraints (WFPP). The GWF approach described above may be applied to the WFPP problem with some modifications. The following presents an algorithm which is a modification of the above discussed GWF, and it is termed as the geometric water-filling with sum and individual peak power constraints (GWFPP). The previously described expression

$${P}_{2} ( k ) = P - {[ {\sum }_{i = 1}^{k - 1} ( {d}_{k} - {d}_{i} ) {w}_{i} ]}^{+} ,$$

k=1, . . . , n may be extended into the new expression:

$${P}_{2} ( {i}_{k} ) = {[ P - {\sum }_{t = 1}^{\vert E \vert - 1} ( {d}_{{i}_{k}} - {d}_{{i}_{t}} ) {w}_{{i}_{t}} ]}^{+} , for k = 1 , … , \vert E \vert$$

where E is a subsequence of the sequence {1, 2, . . . , n}, and |E| is the cardinality of the set E. E may be expressed as {i₁, i₂, . . . , i_{|E|})}. If E is taken as the sequence {1, 2, . . . , n}, then the extended expression may be regressed into the original expression

$${P}_{2} ( k ) = P - {[ {\sum }_{i = 1}^{k - 1} ( {d}_{k} - {d}_{i} ) {w}_{i} ]}^{+} ,$$

k=1, . . . , n. Similarly, some corresponding changes in (13)-(15) are also done (i.e., the subscripts of sequence are replaced with those of the subsequence).

The GWFPP algorithm may be as follows:

Initialize:
vectors {dᵢ}, {wᵢ}, {Pᵢ} for i = 1, 2, ... , n
the set E = {1, 2, ... , n}
total transmit power limit P
Iterative search:
1) Use the explicit solution to the sum rate maximization to compute {sᵢ}
2) Define the set Λ = {i|sᵢ > Pᵢ, i ∈ E}.
$3 ) If Λ is the empty set , output {\{ {s}_{i} \}}_{i = 1}^{n} and exit , else {s}_{i} = {P}_{i} , i ∈ Λ .$
4) Update E with E\Λ and P with P − Σ_{i∈Λ} Pᵢ and return to step 1.

The GWFPP algorithm may be a dynamic power distribution process. The state of this process may be the difference between the individual peak power sequence and the current power distribution sequence obtained by the GWF Algorithm. The control of this process is to use part of the GWF Algorithm

$${s}_{i} = \{ \begin{matrix}[ \frac{{s}_{{k}^{*}}}{{w}_{{k}^{*}}} + ( {d}_{{k}^{*}} - {d}_{i} ) ] {w}_{i} , 1 \leq i \leq {k}^{*} \\ \begin{matrix}0 , & {k}^{*} < i \leq n\end{matrix}\end{matrix} ,$$

where the water level step k*=max {k|P₂(k)>0}, 1≤k≤n and the power level for this step is

$${s}_{{k}^{*}} = \frac{{w}_{{k}^{*}}}{{\sum }_{i = 1}^{{k}^{*}} {w}_{i}} {P}_{2} ( {k}^{*} ) )$$

based on the state mentioned above. Thus, a new state for the next iteration may appear. Therefore, an optimal dynamic power distribution process, the GWFPP, with the state feedback may be formed. Since the finite set E may be getting smaller and smaller until the set A is empty, the GWFPP algorithm may carry out at most n loops (the number of channels) to compute the optimal solution with peak power constraints imposed.

As previously noted, several channel SNR values in the bottom row of table 605 of FIG. 6E and table 705 of FIG. 7E are above the thresholds for the modulation orders in the table 400 of FIG. 4. Imposing individual channel peak power constraints using the GWFPP algorithm on such channels, a modem transmit peak power limit can be imposed that corresponds to the node receive SNR threshold. This may redistribute the excess power in such peak power limited channels to other channels that are close to but under an SNR threshold. This may increase the aggregate bit-loading by increasing the SNR in those underpowered channels.

As described above, the path gains gᵢ, the node post-EC residual level and SNR, the upstream receiver MER, the input noise level Nᵢ to the node, the received MER for each channel, and the OFDMA demodulator received SNR for each upstream channel may be determined. These parameters may be used to determine the optimum individual modem channel transmit levels to maximize capacity (e.g., bitrate) summed across the entire set of upstream OFDMA channels. These parameters may provide input to the GWF algorithm to calculate the optimum transmit power levels constrained only by the sum of the individual channel transmit power levels. The procedure for a node plus amplifier cascade may be follows: 1) Set the maximum total power constraint. The same total power used in a flat receive level across all upstream channels may be used. 2) Measure the post-EC SNR in a period without granting modem transmit opportunities and block all amp upstream noise with wink switches or a similar function. This may yield the node echo residual contribution to the receiver MER. 3) Set the modem target receive level and transmit a test burst from the client device 102 being measured with a calibrated (ranged) transmit power level. 4) Measure the receive level at the network node 108 port and calculate the path gain as the difference of the node receive level minus the modem transmit level. 5) Measure the upstream receiver MER at the node demodulator. 6) Calculate the noise input level as the modem transmit level plus the path gain minus the upstream receiver MER. 7) Calculate the constrained optimum modem transmit powers per channel using the GWF algorithm.

Next, the modem transmit power limit for each channel may be determined as each channel receive level adjusted for the nearest modulation order SNR threshold plus the path gain. The set of adjusted node receive power levels plus the path gain may then become the input individual peak power constraints in the GWFPP algorithm. First, the resulting upstream receive SNR per channel may be measured and the SNR thresholds may be set to the closest lower value of the thresholds in the table 400 of FIG. 4. Second, the individual peak power modem transmit levels for each channel may be computed as the upstream received SNR plus the input noise level minus the path gain. Third, the modem upstream receive levels may be computed and set at the node port as the peak power modem transmit levels plus the path gain. Fourth, the lowest frequency channel may be started with, and the SNR threshold may be increased to the next highest modulation order threshold and the resulting channel SNR values may be recalculated (e.g., remeasured). Then, continue to the next high frequency channel and iterate until there is no significant additional increase in SNR for that channel and stop.

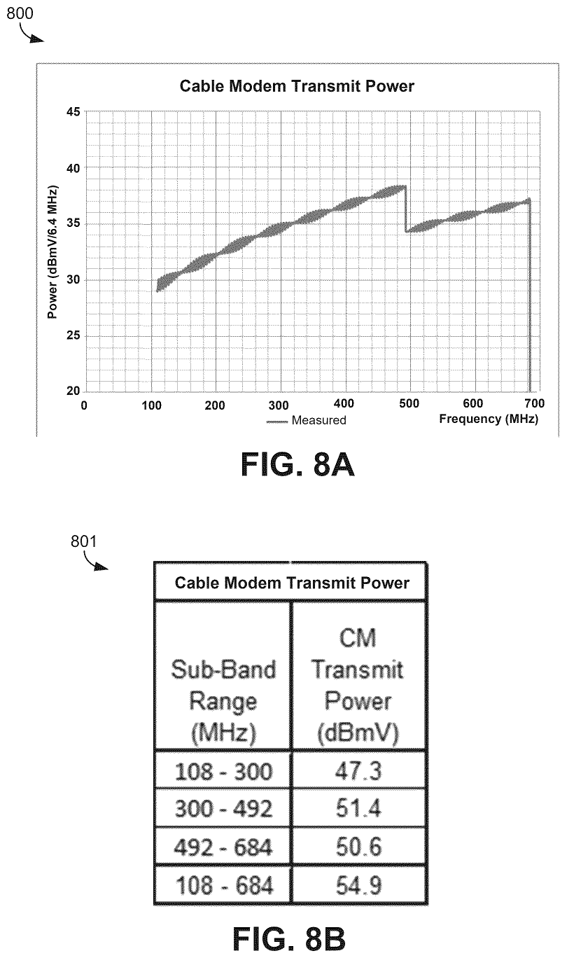

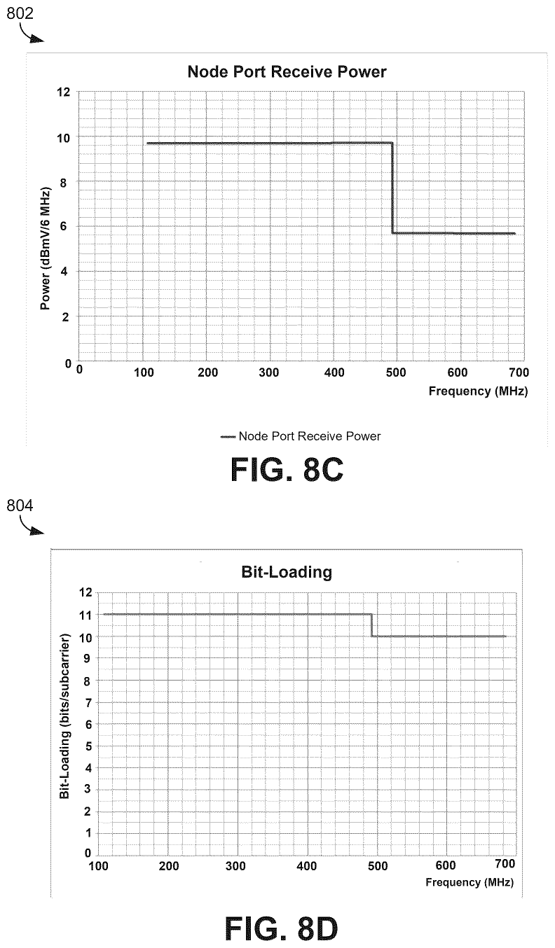

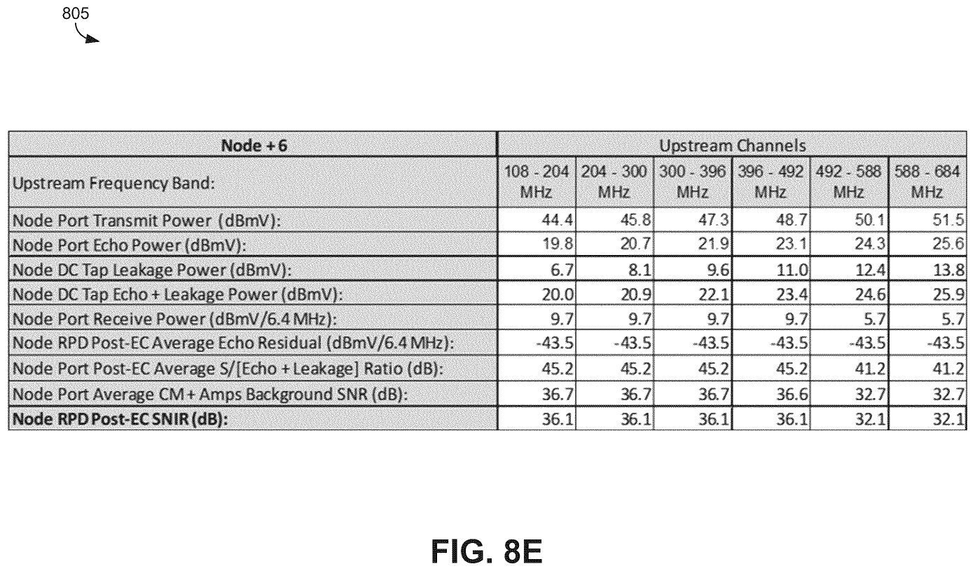

The upstream transmit levels of the client device 102 may be set based on the transmit levels determined using the GWFPP algorithm. FIG. 8A shows a graph 800. The graph 800 indicates the upstream transmit power versus frequency of the client device 102 (in units of dBmV/6.4 MHZ) across a plurality of upstream channels if the client device 102 has a total upstream transmit power of 55 dBmV, and if the upstream transmit levels of the client device 102 are set based on the transmit levels determined using the GWFPP algorithm. For example, the graph 800 indicates the upstream transmit power versus frequency of the client device 102 (in units of dBmV/6.4 MHZ) across six 96 MHz upstream channels in the 108 to 684 MHz frequency band if the client device 102 has a total upstream transmit power of 55 dBmV, and if the upstream transmit levels of the client device 102 are set based on the transmit levels determined using the GWFPP algorithm. FIG. 8B shows a table 801. The table 801 depicts the average upstream transmit power of the client device 102 (in units of dBmV) across the plurality of upstream channels if the client device 102 has a total upstream transmit power of 55 dBmV, and if the upstream transmit levels of the client device 102 are set based on the transmit levels determined using the GWFPP algorithm.

FIG. 8C shows a graph 802 indicating that a non-constant receive power versus frequency is achieved at the network node 108 if the 55 dBmV total transmit power of the client device 102 is allocated across the plurality of channels in the manner shown in FIGS. 8A-8B. FIG. 8D shows a graph 804. The graph 804 indicates an average bit-loading (in units of bits/subcarrier) across the plurality of channels if the non-constant receive power versus frequency shown in FIG. 8C is achieved at the network node 108. For example, the graph 804 indicates that an average bit-loading of 10.7 bits/subcarrier across the plurality of channels is achieved if the non-constant receive power versus frequency shown in FIG. 8C is achieved at the network node 108.

If the average bit-loading across the plurality of channels is equal to 10.7 bits/subcarrier, this may indicate that a total upstream capacity associated with the plurality of channels is equal to approximately 6,144 Mbps. Notably, this is higher than the total upstream capacity described above with regard to FIG. 6D (which is 6,049 Mbps), showing that allocating the transmit power based on the GWFPP algorithm may enable an increased utilization of the available upstream spectrum for the client device 102. In other words, allocating the transmit power based on the iterative GWFPP algorithm may increase capacity of the client device 102 over the uniform network node 108 receive level of FIGS. 2A-E, yielding an increase of 0.7 bit/symbol average across the six upstream channel with a resultant 6.7 percent (6144/5760) increase in bitrate.

FIG. 8E shows a table 805. The table 805 indicates the network node 108 port transmit and receive signal levels, echo interference levels, network node 108 signal to interference ratio (SIR), amplifier cascade SNR, and the combined network node 108 SNIR if the 55 dBmV total transmit power of the client device 102 is allocated across the plurality of channels in the manner shown in FIGS. 8A-8B. All channel SNIR values in the bottom row of the table 805 are now at the thresholds for the modulation orders in the table 400 of FIG. 4. Bit-loading has been redistributed with a net gain over the GWF algorithm from 5 percent to 6.7 percent over the fixed receive level channels case.

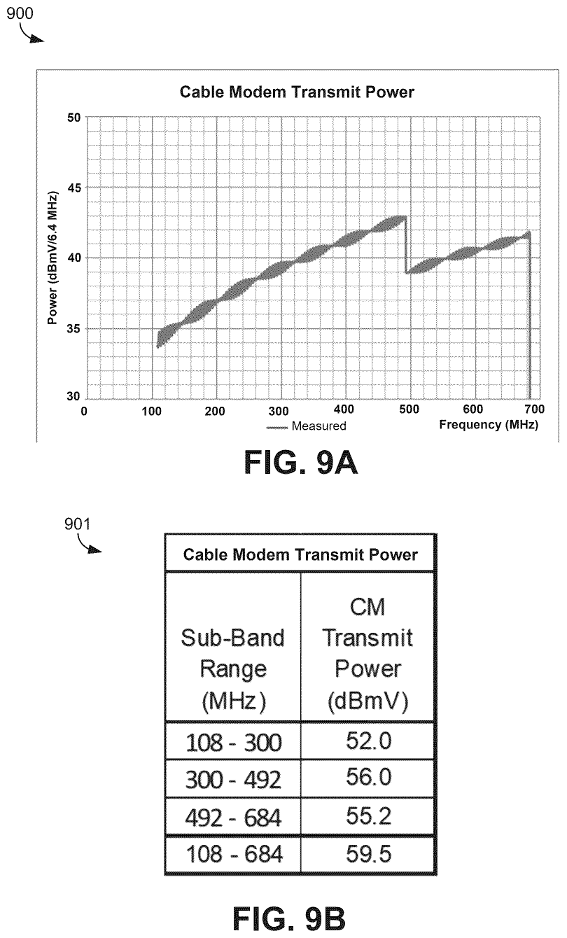

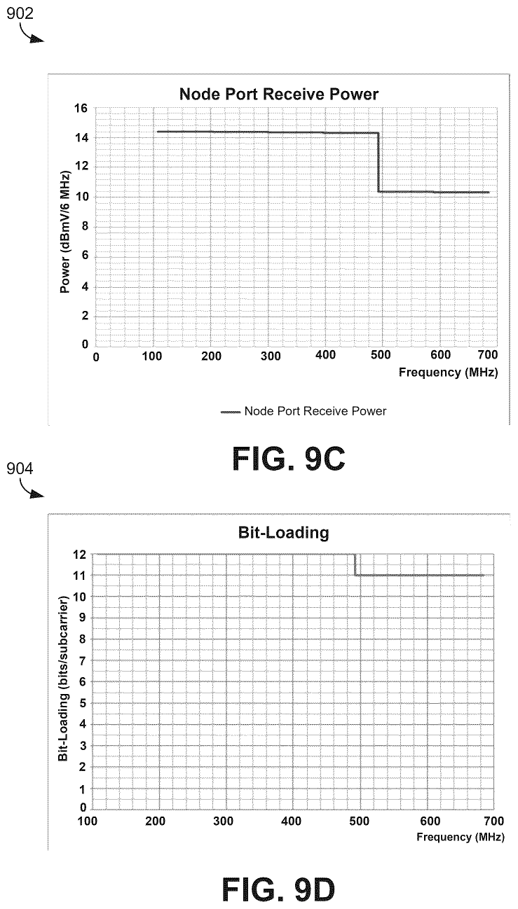

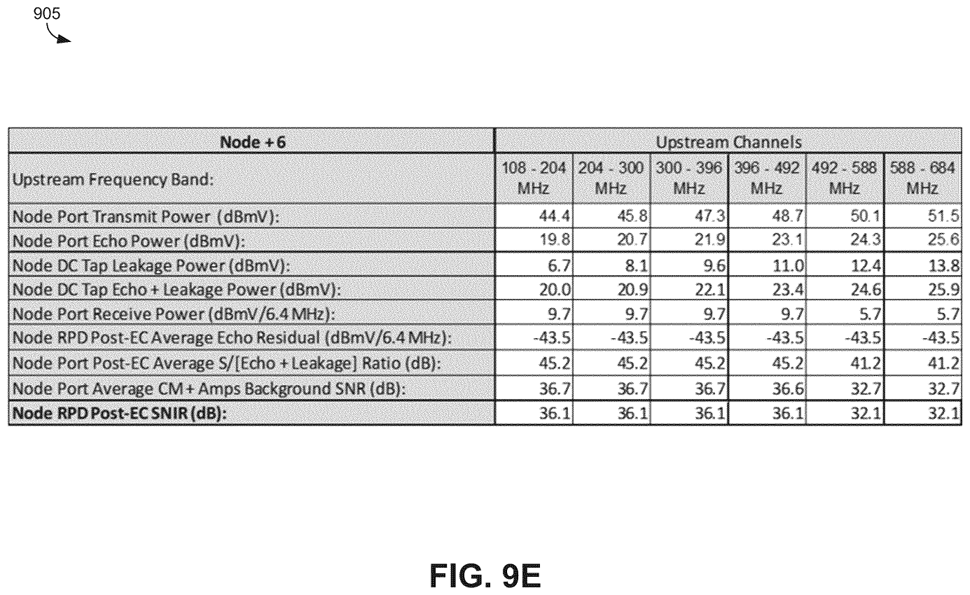

FIG. 9A shows a graph 900. The graph 900 indicates the upstream transmit power versus frequency of the client device 102 (in units of dBmV/6.4 MHZ) across a plurality of upstream channels if the client device 102 has a total upstream transmit power of 59 dBmV, and if the upstream transmit levels of the client device 102 are set based on the transmit levels determined using the GWFPP algorithm. For example, the graph 900 indicates the upstream transmit power versus frequency of the client device 102 (in units of dBmV/6.4 MH2) across six 96 MHz upstream channels in the 108 to 684 MHz frequency band if the client device 102 has a total upstream transmit power of 59 dBmV, and if the upstream transmit levels of the client device 102 are set based on the transmit levels determined using the GWFPP algorithm. FIG. 9B shows a table 901. The table 901 depicts the average upstream transmit power of the client device 102 (in units of dBmV) across the plurality of upstream channels if the client device 102 has a total upstream transmit power of 59 dBmV, and if the upstream transmit levels of the client device 102 are set based on the transmit levels determined using the GWFPP algorithm.

FIG. 9C shows a graph 902 indicating that a non-constant receive power versus frequency is achieved at the network node 108 if the 59 dBmV total transmit power of the client device 102 is allocated across the plurality of channels in the manner shown in FIGS. 9A-9B. FIG. 9D shows a graph 904. The graph 904 indicates an average bit-loading (in units of bits/subcarrier) across the plurality of channels if the non-constant receive power versus frequency shown in FIG. 9C is achieved at the network node 108. For example, the graph 904 indicates that an average bit-loading of 11.7 bits/subcarrier across the plurality of channels is achieved if the non-constant receive power versus frequency shown in FIG. 9C is achieved at the network node 108.

If the average bit-loading across the plurality of channels is equal to 11.7 bits/subcarrier, this may indicate that a total upstream capacity associated with the plurality of channels is equal to approximately 6,720 Mbps. Notably, this is higher than the total upstream capacity described above with regard to FIG. 7D (which is 6,144 Mbps), showing that allocating the transmit power based on the GWFPP algorithm may enable an increased utilization of the available upstream spectrum for the client device 102. In other words, allocating the transmit power based on the GWFPP algorithm may increase capacity of the client device 102 over the uniform network node 108 receive level of FIGS. 3A-E, yielding an increase of 0.7 bit/symbol average across the six upstream channel with a resultant 6.1 percent (6720/6336) increase in bitrate.

FIG. 9E shows a table 905. The table 905 indicates the network node 108 port transmit and receive signal levels, echo interference levels, network node 108 signal to interference ratio (SIR), amplifier cascade SNR, and the combined network node 108 SNIR if the 59 dBmV total transmit power of the client device 102 is allocated across the plurality of channels in the manner shown in FIGS. 9A-9B. All channel SNIR values in the bottom row of the table 905 are now at the thresholds for the modulation orders in the table 400 of FIG. 4. Bit-loading has been redistributed with a net gain over the GWF algorithm from 1.5 percent to 6 percent over the fixed receive level channels case.

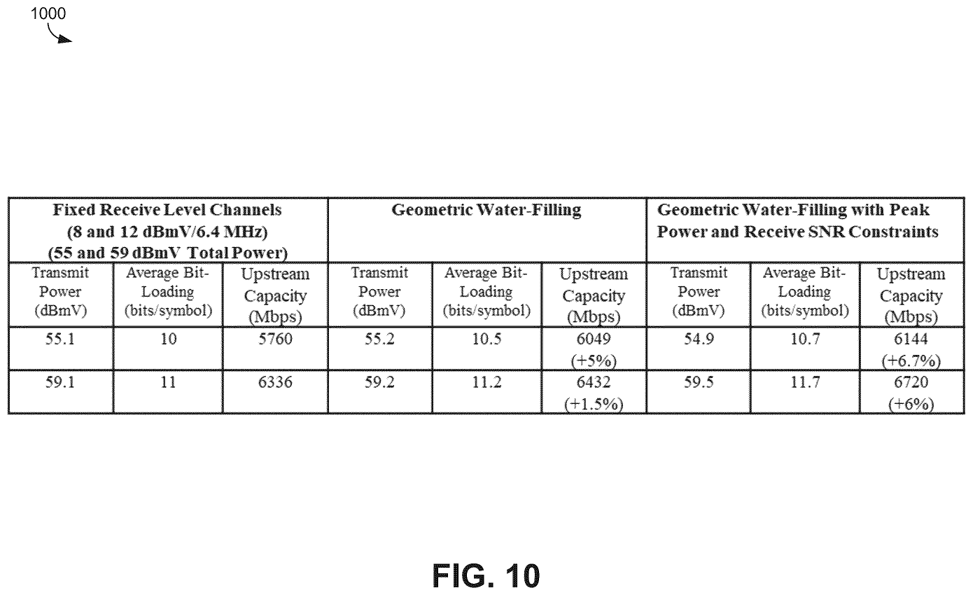

FIG. 10 shows a table 1000. The table 1000 summarizes the results of the use of the various transmit power allocations described above. The first three columns of the table 1000 indicate the results if upstream transmit levels of a user device (e.g., client device 102) are set to cause a constant receive power versus frequency at the network (e.g., at the network node 108), as described above with regards to FIGS. 2A-E and FIGS. 3A-E. As shown in the table 1000, for a user device with a total upstream transmit power of approximately 55 dBmV, if upstream transmit levels of a user device (e.g., client device 102) are set to cause a constant receive power versus frequency of 8 dBmV/6.4 MHz at the network (e.g., at the network node 108), an average bit-loading of 10 bits/symbol and an upstream capacity of 5760 Mbps may be achieved. For a user device with a total upstream transmit power of approximately 59 dBmV, if upstream transmit levels of a user device (e.g., client device 102) are set to cause a constant receive power versus frequency of 12 dBmV/6.4 MHz at the network (e.g., at the network node 108), an average bit-loading of 11 bits/symbol and an upstream capacity of 6336 Mbps may be achieved.

The middle three columns of the table 1000 indicate the results if upstream transmit levels of a user device (e.g., client device 102) are set based on a transmit power allocation determined based on a water-filling algorithm, as described above with regards to FIGS. 6A-E and FIGS. 7A-E. As shown in the table 1000, for a user device with a total upstream transmit power of approximately 55 dBmV, if upstream transmit levels of a user device (e.g., client device 102) are set based on a transmit power allocation determined based on a water-filling algorithm, an average bit-loading of 10.5 bits/symbol and an upstream capacity of 6049 Mbps may be achieved. This may represent a five percent increase in capacity as compared to the setting the upstream transmit levels of the user device to cause a constant receive power versus frequency of 8 dBmV/6.4 MHz at the network. For a user device with a total upstream transmit power of approximately 59 dBmV, if upstream transmit levels of a user device (e.g., client device 102) are set based on a transmit power allocation determined based on a water-filling algorithm, an average bit-loading of 11.2 bits/symbol and an upstream capacity of 6432 Mbps may be achieved. This may represent a 1.5 percent increase in capacity as compared to the setting the upstream transmit levels of the user device to cause a constant receive power versus frequency of 12 dBmV/6.4 MHz at the network.

The last three columns of the table 1000 indicate the results if upstream transmit levels of a user device (e.g., client device 102) are set based on the GWFPP algorithm, as described above with regards to FIGS. 8A-E and FIGS. 9A-E. As shown in the table 1000, for a user device with a total upstream transmit power of approximately 55 dBmV, if upstream transmit levels of a user device (e.g., client device 102) are set based on the GWFPP algorithm, an average bit-loading of 10.7 bits/symbol and an upstream capacity of 6144 Mbps may be achieved. This may represent a 6.7 percent increase in capacity as compared to the setting the upstream transmit levels of the user device to cause a constant receive power versus frequency of 8 dBmV/6.4 MHz at the network. For a user device with a total upstream transmit power of approximately 59 dBmV, if upstream transmit levels of a user device (e.g., client device 102) are set based on a transmit power allocation determined based on the GWFPP algorithm, an average bit-loading of 11.7 bits/symbol and an upstream capacity of 6720 Mbps may be achieved. This may represent a six percent increase in capacity as compared to the setting the upstream transmit levels of the user device to cause a constant receive power versus frequency of 12 dBmV/6.4 MHz at the network.

The results depicted in the table 1000 show that the improved DOCSIS-based water-filling solution described herein may improve capacity within existing DOCSIS protocols and cable modem operation. Upstream capacity/bitrate may be improved using the sum rate maximization of the Shannon Channel Capacity bound across multiple upstream channels. The solution to this sum rate maximization may yield a continuous function of SNR. However, the OFDM modulation used in DOCSIS 4.0 may be a discontinuous function of capacity versus SNR. A further optimization of upstream capacity/bitrate using the GWFPP algorithm may increase the realized OFDMA channel capacity without increasing the total transmit power constraint using individual peak power limits on each channel. The peak power values may be derived from the SNR thresholds for the OFDM modulation orders, as shown in the table 400 of FIG. 4. Capacity improvements may be at least six percent for a typical network example within the same or lower modem total transmit power. More bits/s/Hz may increase system capacity within the same power and bandwidth. Operational efficiency may therefore be improved. As a result, higher service tiers may be better supported and/or more headroom for existing service tiers may be provided. More headroom may increase reliability for providing more consistent service to customers.

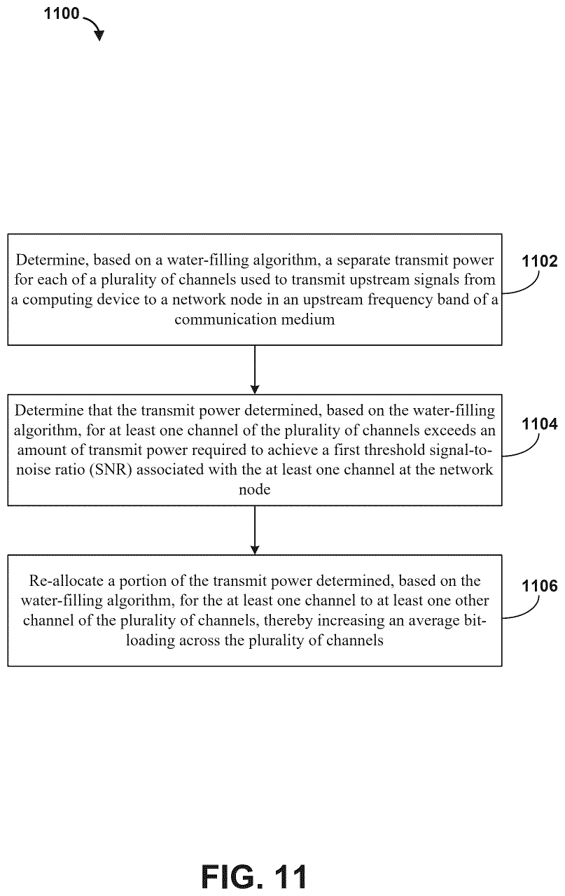

FIG. 11 shows an example method 1100. The method 1100 may comprise a computer implemented method for performing a water-filling calculation and managing transmit power. A system and/or computing environment, such as the system 100 of FIG. 1 may be configured to perform the method 1100. For example, the client device 102 and/or the server device 120 may be configured to perform the method 1100.

If the upstream transmit levels of a computing device (e.g., a cable modem compliant with DOCSIS 4.0) are set to cause a constant receive power versus frequency at a network node, the increase in available upstream spectrum provided by the DOCSIS 4.0 specification may be underutilized (e.g., the full potential increase in capacity may not be achieved). To better utilize the increase in available upstream spectrum for the computing device, a water-filling algorithm may be used to allocate the total upstream transmit power associated with the computing device across a plurality of upstream channels.

At 1102, a separate transmit power may be determined for each of a plurality of channels used to transmit upstream signals from a computing device to a network node in an upstream frequency band of a communication medium. Each of the plurality of channels may comprise an OFDMA channel. The communication medium may comprise at least an HFC cable connection between the network node and the computing device. The upstream frequency band may comprise frequencies in a range of about 108 MHZ to 684 MHZ. The separate transmit power for each of the plurality of upstream channels may be determined based on a water-filling algorithm. The water-filling algorithm may comprise at least one of a conventional water-filling algorithm or a geometric water-filling algorithm. Determining, based on the water-filling algorithm, the separate transmit power for each of the plurality of channels may comprise determining, for each of the plurality of channels, a transmit power level that is inversely proportional to an amount of path loss associated with the channel.

The transmit power allocation determined based on the water-filling algorithm may enable an increased utilization of the available upstream spectrum for the computing device. However, the available upstream spectrum may still be underutilized (e.g., the full potential increase in capacity may still not be achieved).

The transmit power allocation determined based on the water-filling algorithm may be modified. At 1104, it may be determined that the transmit power that was determined, based on the water-filling algorithm, for at least one channel of the plurality of channels exceeds an amount of transmit power required to achieve a first threshold signal-to-noise ratio (SNR) associated with the at least one channel at the network node. The transmit power allocation determined based on the water-filling algorithm may be modified based on (e.g., in response to) determining that the separate transmit power determined, based on the water-filling algorithm, for the at least one channel exceeds the amount of transmit power required to achieve the first SNR threshold associated with the at least one channel at the network node. The first SNR threshold may comprise a SNR that is required for the network node to receive a signal via the at least one channel at a first threshold modulation level (e.g., a threshold QAM level). For example, the first SNR threshold may comprise 29.5 dB if the first threshold modulation level is 512-QAM, the first SNR threshold may comprise 32 dB if the first threshold modulation level is 1024-QAM, the first SNR threshold may comprise 36 dB if the first threshold modulation level is 2048-QAM, and so on.

If the transmit power that was determined, based on the water-filling algorithm, for the at least one channel exceeds the amount of transmit power required to achieve the first threshold SNR associated with the at least one channel at the network node, this may indicate that, even if a portion of the separate transmit power determined, based on the water-filling algorithm, for the at least one channel is re-allocated to at least one other channel of the plurality of channels, signal(s) sent to the network node via the at least one channel may still be received at the network node at the first threshold modulation level.

At 1106, a portion of the transmit power determined, based on the water-filling algorithm, for the at least one channel may be re-allocated to at least one other channel of the plurality of channels. The re-allocating the portion of the transmit power determined, based on the water-filling algorithm, for the at least one channel to the at least one other channel may be based on (e.g., in response to) determining that the transmit power, determined, based on the water-filling algorithm, for the at least one other channel is less than an amount of transmit power required to achieve a second threshold SNR associated with the at least one other channel at the network node. The second SNR threshold may comprise a SNR that is required for the network node to receive a signal via the at least one other channel at a second threshold modulation level (e.g., a threshold QAM level). For example, the second SNR threshold may comprise 29.5 dB if the second threshold modulation level is 512-QAM, the second SNR threshold may comprise 32 dB if the second threshold modulation level is 1024-QAM, the second SNR threshold may comprise 36 dB if the second threshold modulation level is 2048-QAM, and so on. The first threshold SNR may be different from the second threshold SNR (e.g., the first threshold modulation level may be different from the second threshold modulation level). The first threshold SNR may the same as the second threshold SNR (e.g., the first threshold modulation level may be the same as the second threshold modulation level). Re-allocating the portion of the transmit power determined, based on the water-filling algorithm, for the at least one channel to the at least one other channel may increase an average bit-loading across the plurality of channels (e.g., may optimize the upstream capacity of the computing device). The computing device may be caused to transmit the upstream signals to the network node based on the modified allocation of the total transmit power.

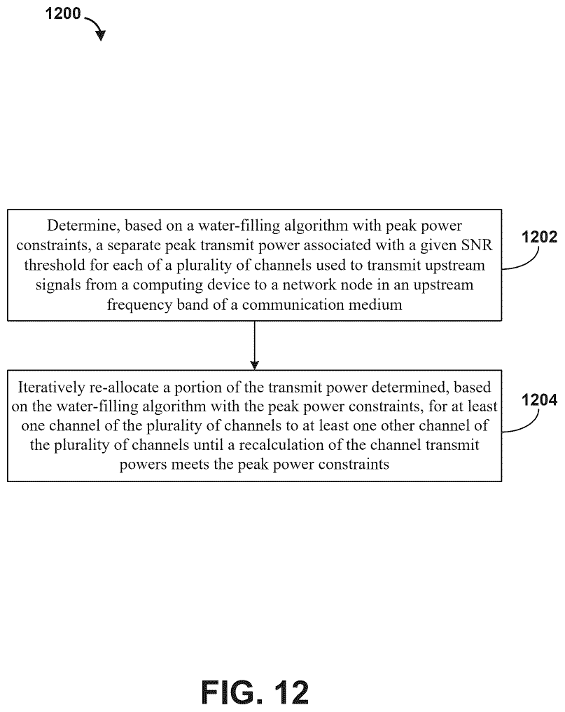

FIG. 12 shows an example method 1200. The method 1200 may incorporate geometric water-filling but with peak power constraints, iteratively. The method 1200 may comprise a computer implemented method for managing transmit power. A system and/or computing environment, such as the system 100 of FIG. 1 may be configured to perform the method 1200. For example, the client device 102 and/or the server device 120 may be configured to perform the method 1200.

If the upstream transmit levels of a computing device (e.g., a cable modem compliant with DOCSIS 4.0) are set to cause a constant receive power versus frequency at a network node, the increase in available upstream spectrum provided by the DOCSIS 4.0 specification may be underutilized (e.g., the full potential increase in capacity may not be achieved). To better utilize the increase in available upstream spectrum for the computing device, a water-filling algorithm may be used to allocate the total upstream transmit power associated with the computing device across a plurality of upstream channels.

At 1202, a separate transmit power (e.g., peak transmit power) for a given SNR threshold may be imposed for each of a plurality of channels used to transmit upstream signals from a computing device to a network node in an upstream frequency band of a communication medium. Each of the plurality of channels may comprise an OFDMA channel. The communication medium may comprise at least an HFC cable connection between the network node and the computing device. The upstream frequency band may comprise frequencies in a range of about 108 MHZ to 684 MHz. The separate transmit power for each of the plurality of upstream channels may be determined based on a water-filling algorithm (e.g., a water-filling algorithm with peak power constraints). The water-filling algorithm may comprise at least one of a conventional water-filling algorithm or a geometric water-filling algorithm. Determining, based on the water-filling algorithm, the separate transmit power for each of the plurality of channels may comprise determining, for each of the plurality of channels, a transmit power level that is inversely proportional to an amount of path loss associated with the channel.

The transmit power allocation determined based on the water-filling algorithm (e.g., the water filling algorithm with peak power constraints) may enable an increased utilization of the available upstream spectrum for the computing device. However, the available upstream spectrum may still be underutilized (e.g., the full potential increase in capacity may still not be achieved). The transmit power allocation determined based on the water-filling algorithm (e.g., the water filling algorithm with peak power constraints) may be modified. At 1204, a portion of the transmit power determined, based on the water-filling algorithm (e.g., the water filling algorithm with peak power constraints), for at least one channel of the plurality of channels may be iteratively re-allocated to at least one other channel of the plurality of channels until the recalculation of the channel transmit powers results in the peak power constraints being met for each channel. For example, the at least one channel of the plurality of channels may be iteratively re-allocated to at least one other channel of the plurality of channels until an average bit-loading across the plurality of channels satisfies a threshold level.

The portion of the transmit power determined, based on the water-filling algorithm, for the at least one channel may be re-allocated to the at least one other channel if the transmit power determined, based on the water-filling algorithm, for the at least one channel exceeds an amount of transmit power required to achieve a first threshold SNR associated with the at least one channel at the network node. The first SNR threshold may comprise a SNR that is required for the network node to receive a signal via the at least one channel at a first threshold modulation level (e.g., a threshold QAM level). For example, the first SNR threshold may comprise 29.5 dB if the first threshold modulation level is 512-QAM, the first SNR threshold may comprise 32 dB if the first threshold modulation level is 1024-QAM, the first SNR threshold may comprise 36 dB if the first threshold modulation level is 2048-QAM, and so on.

The re-allocating the portion of the transmit power determined, based on the water-filling algorithm with peak power constraints, for the at least one channel to the at least one other channel may be based on (e.g., in response to) determining that the transmit power, determined, based on the water-filling algorithm, for the at least one other channel is less than an amount of transmit power required to achieve a second threshold SNR associated with the at least one other channel at the network node. The second SNR threshold may comprise a SNR that is required for the network node to receive a signal via the at least one other channel at a second threshold modulation level (e.g., a threshold QAM level). For example, the second SNR threshold may comprise 29.5 dB if the second threshold modulation level is 512-QAM, the second SNR threshold may comprise 32 dB if the second threshold modulation level is 1024-QAM, the second SNR threshold may comprise 36 dB if the second threshold modulation level is 2048-QAM, and so on. The first threshold SNR may be different from the second threshold SNR (e.g., the first threshold modulation level may be different from the second threshold modulation level). The first threshold SNR may be the same as the second threshold SNR (e.g., the first threshold modulation level may be the same as the second threshold modulation level). Re-allocating the portion of the transmit power determined, based on the water-filling algorithm with peak power constraints, for the at least one channel to the at least one other channel may increase an average bit-loading across the plurality of channels (e.g., may optimize the upstream capacity of the computing device). The computing device may be caused to transmit the upstream signals to the network node based on the modified allocation of the total transmit power. The resulting recalculated peak power transmit levels in each channel may result in a changed received SNR in each channel. This will require iterative repetitions of this method 1200 since each successive algorithm calculation changes the received SNR. The algorithm converges as the magnitude of the SNR changes diminish with each iteration.

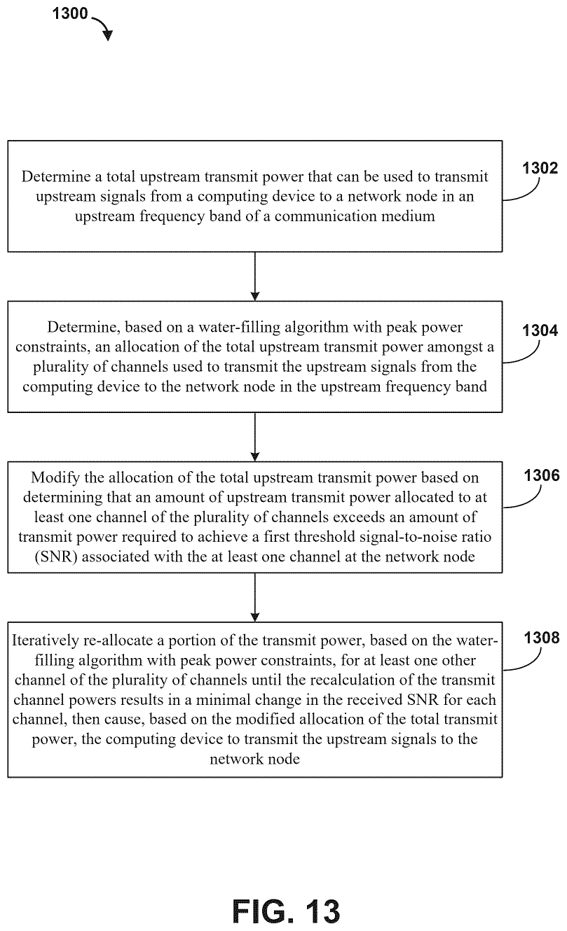

FIG. 13 shows an example method 1300 that iterates method 1200. The method 1300 may comprise a computer implemented method for managing transmit power. A system and/or computing environment, such as the system 100 of FIG. 1 may be configured to perform the method 1300. For example, the client device 102 and/or the server device 120 may be configured to perform the method 1300.

At 1302, a total upstream transmit power associated with a computing device may be determined. The total upstream transmit power may comprise the total transmit power that can be used to transmit upstream signals from the computing device to a network node in an upstream frequency band of a communication medium. The total upstream transmit power associated with the computing device may comprise, for example, 55 dBmV, 59 dBmV, or any other total upstream transmit power. The computing device may comprise, for example, a cable modem compliant with DOCSIS 4.0. The upstream frequency band may comprise frequencies in a range of about 108 MHz to 684 MHz. The communication medium may comprise at least an HFC cable connection between the network node and the computing device. The computing device may utilize a plurality of channels to transmit upstream signals to the network node the upstream frequency band. Each of the plurality of channels may comprise an OFDMA channel.

If the upstream transmit levels of the computing device are set to cause a constant receive power versus frequency at the network node, the increase in available upstream spectrum provided by the DOCSIS 4.0 specification may be underutilized (e.g., the full potential increase in capacity may not be achieved). To better utilize the increase in available upstream spectrum for the computing device, a water-filling algorithm with peak power constraints may be used to allocate the total upstream transmit power associated with the computing device across the plurality of upstream channels. At 1304, an allocation of the total upstream transmit power amongst the plurality of channels may be determined. The allocation of the total upstream transmit power amongst the plurality of channels may be determined based on a water-filling algorithm (e.g., a water filling algorithm with peak power constraints).

The transmit power allocation determined based on the water-filling algorithm (e.g., the water filling algorithm with peak power constraints) may enable an increased utilization of the available upstream spectrum for the computing device. However, the available upstream spectrum may still be underutilized (e.g., the full potential increase in capacity may still not be achieved). The transmit power allocation determined based on the water-filling algorithm (e.g., the water filling algorithm with peak power constraints) may be modified. At 1306, the allocation of the total upstream transmit power may be modified based on determining that an amount of upstream transmit power allocated to at least one channel of the plurality of channels exceeds an amount of transmit power required to achieve a first threshold SNR associated with the at least one channel at the network node. The first SNR threshold may comprise a SNR that is required for the network node to receive a signal via the at least one channel at a first threshold modulation level (e.g., a threshold QAM level). For example, the first SNR threshold may comprise 29.5 dB if the first threshold modulation level is 512-QAM, the first SNR threshold may comprise 32 dB if the first threshold modulation level is 1024-QAM, the first SNR threshold may comprise 36 dB if the first threshold modulation level is 2048-QAM, and so on.

Modifying the allocation of the total upstream transmit power may comprise re-allocating a portion of the transmit power determined, based on the water-filling algorithm (e.g., the water filling algorithm with peak power constraints), for the at least one channel to at least one other channel. The transmit power, determined, based on the water-filling algorithm (e.g., the water filling algorithm with peak power constraints), for the at least one other channel may be less than an amount of transmit power required to achieve a second threshold SNR associated with the at least one other channel at the network node. The second SNR threshold may comprise a SNR that is required for the network node to receive a signal via the at least one other channel at a second threshold modulation level (e.g., a threshold QAM level). For example, the second SNR threshold may comprise 29.5 dB if the second threshold modulation level is 512-QAM, the second SNR threshold may comprise 32 dB if the second threshold modulation level is 1024-QAM, the second SNR threshold may comprise 36 dB if the second threshold modulation level is 2048-QAM, and so on. The first threshold SNR may be different from the second threshold SNR (e.g., the first threshold modulation level may be different from the second threshold modulation level). The first threshold SNR may the same as the second threshold SNR (e.g., the first threshold modulation level may be the same as the second threshold modulation level).

Re-allocating the portion of the transmit power determined, based on the water-filling algorithm, for the at least one channel to at least one other channel may comprise iteratively re-allocating a portion of the transmit power determined, based on the water-filling algorithm, for at least one channel of the plurality of channels to at least one other channel of the plurality of channels until a recalculation of the channel transmit powers results in a minimal change (e.g., a change that satisfies a threshold level) in the received SNR for each channel. Re-allocating the portion of the transmit power determined, based on the water-filling algorithm (e.g., the water filling algorithm with peak power constraints), for the at least one channel to the at least one other channel may increase an average bit-loading across the plurality of channels (e.g., may optimize the upstream capacity of the computing device). At 1308, the computing device may be caused to transmit the upstream signals to the network node based on the modified allocation of the total transmit power.

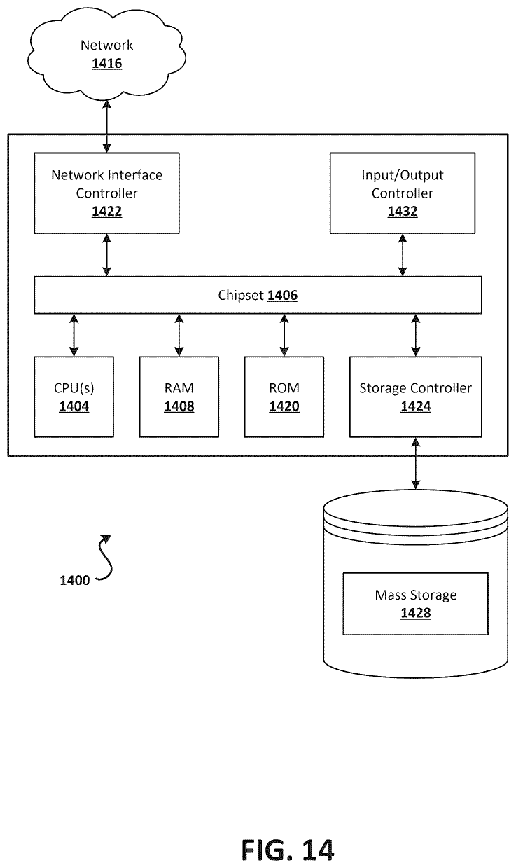

FIG. 14 shows an example computing device 1400 that may represent any of the various devices or entities shown in FIG. 1, including, for example, the server device 120, the network node 108, the amplifier(s) 106, the tap(s) 104, and/or the client device 102. That is, the computing device 1400 shown in FIG. 14 may be any smartphone, server computer, workstation, access point, router, gateway, tablet computer, laptop computer, notebook computer, desktop computer, personal computer, television, network appliance, PDA, e-reader, user equipment (UE), mobile station, fixed or mobile subscriber unit, pager, wireless sensor, consumer electronics, or other computing device, and may be utilized to execute any aspects of the methods and apparatus described herein, such as to implement any of the various devices or entities shown in FIG. 1 or any of the methods described in relation to FIGS. 11-13.

The computing device 1400 may include a baseboard, or “motherboard,” which is a printed circuit board to which a multitude of components or devices may be connected by way of a system bus or other electrical communication paths. One or more central processing units (CPUs or “processors”) 1404 may operate in conjunction with a chipset 1406. The CPU(s) 1404 may be standard programmable processors that perform arithmetic and logical operations necessary for the operation of the computing device 1400.

The CPU(s) 1404 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 1404 may be augmented with or replaced by other processing units, such as GPU(s) 1405. The GPU(s) 1405 may comprise processing units specialized for but not necessarily limited to highly parallel computations, such as graphics and other visualization-related processing.

A chipset 1406 may provide an interface between the CPU(s) 1404 and the remainder of the components and devices on the baseboard. The chipset 1406 may provide an interface to a random-access memory (RAM) 1408 used as the main memory in the computing device 1400. The chipset 1406 may provide an interface to a computer-readable storage medium, such as a read-only memory (ROM) 1420 or non-volatile RAM (NVRAM) (not shown), for storing basic routines that may help to start up the computing device 1400 and to transfer information between the various components and devices. ROM 1420 or NVRAM may also store other software components necessary for the operation of the computing device 1400 in accordance with the aspects described herein.

The computing device 1400 may operate in a networked environment using logical connections to remote computing nodes and computer systems through local area network (LAN) 1416. The chipset 1406 may include functionality for providing network connectivity through a network interface controller (NIC) 1422. A NIC 1422 may be capable of connecting the computing device 1400 to other computing nodes over the network 1416. It should be appreciated that multiple NICs 1422 may be present in the computing device 1400, connecting the computing device to other types of networks and remote computer systems. The NIC may be configured to implement a wired local area network technology, such as IEEE 802.3 (“Ethernet”) or the like. The NIC 1422 may also comprise any suitable wireless network interface controller capable of wirelessly connecting and communicating with other devices or computing nodes. For example, the NIC 1422 may operate in accordance with any of a variety of wireless communication protocols, including for example, the IEEE 802.11 (“Wi-Fi”) protocol, the IEEE 802.16 or 802.20 (“WiMAX”) protocols, the IEEE 802.15.4a (“Zigbee”) protocol, the 802.15.3c (“UWB”) protocol, one or more Bluetooth protocols, and/or the like.

The computing device 1400 may be connected to a mass storage device 1426 that provides non-volatile storage (i.e., memory) for the computer. The mass storage device 1426 may store system programs, application programs, other program modules, and data, which have been described in greater detail herein. The mass storage device 1426 may be connected to the computing device 1400 through a storage controller 1424 connected to the chipset 1406. The mass storage device 1426 may consist of one or more physical storage units. A storage controller 1424 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 1400 may store data on a mass storage device 1426 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 1426 is characterized as primary or secondary storage and the like.

For example, the computing device 1400 may store information to the mass storage device 1426 by issuing instructions through a storage controller 1424 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 1400 may read information from the mass storage device 1426 by detecting the physical states or characteristics of one or more particular locations within the physical storage units.

In addition to the mass storage device 1426 described herein, the computing device 1400 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 1400.

By way of example and not limitation, computer-readable storage media may include volatile and non-volatile, non-transitory computer-readable storage media, and removable and non-removable media implemented in any method or technology. However, as used herein, the term computer-readable storage media does not encompass transitory computer-readable storage media, such as signals. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other non-transitory medium that may be used to store the desired information in a non-transitory fashion.

A mass storage device, such as the mass storage device 1426 depicted in FIG. 14, may store an operating system utilized to control the operation of the computing device 1400. The operating system may comprise a version of the LINUX operating system. The operating system may comprise a version of the WINDOWS SERVER operating system from the MICROSOFT Corporation. According to additional aspects, the operating system may comprise a version of the UNIX operating system. Various mobile phone operating systems, such as IOS and ANDROID, may also be utilized. It should be appreciated that other operating systems may also be utilized. The mass storage device 1428 may store other system or application programs and data utilized by the computing device 1400.

The mass storage device 1426 or other computer-readable storage media may also be encoded with computer-executable instructions, which, when loaded into the computing device 1400, transforms the computing device from a general-purpose computing system into a special-purpose computer capable of implementing the aspects described herein. These computer-executable instructions transform the computing device 1400 by specifying how the CPU(s) 1404 transition between states, as described herein. The computing device 1400 may have access to computer-readable storage media storing computer-executable instructions, which, when executed by the computing device 1400, may perform the methods described in relation to FIGS. 11-13.

A computing device, such as the computing device 1400 depicted in FIG. 14, may also include an input/output controller 1432 for receiving and processing input from a number of input devices, such as a keyboard, a mouse, a touchpad, a touch screen, an electronic stylus, or other type of input device. Similarly, an input/output controller 1432 may provide output to a display, such as a computer monitor, a flat-panel display, a digital projector, a printer, a plotter, or other type of output device. It will be appreciated that the computing device 1400 may not include all of the components shown in FIG. 14, may include other components that are not explicitly shown in FIG. 14, or may utilize an architecture completely different than that shown in FIG. 14.

As described herein, a computing device may be a physical computing device, such as the computing device 1400 of FIG. 14. A computing device may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems described herein are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes¬from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey data indicating a preferred or ideal embodiment. “Such as” is not used in a restrictive sense, but for explanatory purposes.

Components and devices are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable instructions (e.g., computer software or program code) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described above with reference to block diagrams and flowchart illustrations of methods, systems, apparatuses, and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described herein may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are shown as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the shown computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method comprising:
determining, based on a water-filling algorithm, a separate transmit power for each of a plurality of channels used to transmit upstream signals from a computing device to a network node in an upstream frequency band of a communication medium;
determining that the transmit power determined, based on the water-filling algorithm, for at least one channel of the plurality of channels exceeds an amount of transmit power required to achieve a first threshold signal-to-noise ratio (SNR) associated with the at least one channel at the network node; and
re-allocating a portion of the transmit power determined, based on the water-filling algorithm, for the at least one channel to at least one other channel of the plurality of channels, thereby increasing an average bit-loading across the plurality of channels.

2. The method of claim 1, wherein determining, based on the water-filling algorithm, the separate transmit power for each of the plurality of channels comprises determining, for each of the plurality of channels, a transmit power level that is inversely proportional to an amount of path loss associated with the channel.

3. The method of claim 1, wherein the water-filling algorithm comprises a geometric water-filling algorithm.

4. The method of claim 1, wherein the first threshold SNR comprises a SNR that is required for the network node to receive a signal via the at least one channel at a threshold modulation level.

5. The method of claim 1, wherein the re-allocating the portion of the transmit power determined, based on the water-filling algorithm, for the at least one channel to the at least one other channel is based on determining that the transmit power, determined, based on the water-filling algorithm, for the at least one other channel is less than an amount of transmit power required to achieve a second threshold SNR associated with the at least one other channel at the network node.

6. The method of claim 5, wherein the first threshold SNR is different from the second threshold SNR.

7. The method of claim 1, wherein each of the plurality of channels comprises an orthogonal frequency-division multiple access (OFDMA) channel.

8. The method of claim 1, wherein the communication medium comprises at least a hybrid fiber coax (HFC) cable connection between the network node and the computing device.

9. The method of claim 1, wherein the upstream frequency band comprises frequencies in a range of about 108 megahertz (MHz) to 684 MHz.

10. The method of claim 1, wherein the computing device comprises a modem compliant with DOCSIS 4.0.

11. A method comprising:
determining, based on a water-filling algorithm, a separate transmit power for each of a plurality of channels used to transmit upstream signals from a computing device to a network node in an upstream frequency band of a communication medium; and
iteratively re-allocating a portion of the transmit power determined, based on the water-filling algorithm, for at least one channel of the plurality of channels to at least one other channel of the plurality of channels until an average bit-loading across the plurality of channels satisfies a threshold level, wherein the portion of the transmit power determined, based on the water-filling algorithm, for the at least one channel is re-allocated to the at least one other channel based on the transmit power determined, based on the water-filling algorithm, for the at least one channel exceeding an amount of transmit power required to achieve a threshold signal-to-noise ratio (SNR) associated with the at least one channel at the network node.

12. The method of claim 11, wherein the re-allocating the portion of the transmit power determined, based on the water-filling algorithm, for the at least one channel to the at least one other channel increases an average bit-loading across the plurality of channels.

13. The method of claim 11, wherein determining, based on the water-filling algorithm, the separate transmit power for each of the plurality of channels comprises determining, for each of the plurality of channels, a transmit power level that is inversely proportional to an amount of path loss associated with the channel.

14. The method of claim 11, wherein the water-filling algorithm comprises a geometric water-filling algorithm.

15. The method of claim 11, wherein the threshold SNR comprises a SNR that is required for the network node to receive a signal via the at least one channel at a threshold modulation level.

16. A method comprising:
determining a total upstream transmit power that can be used to transmit upstream signals from a computing device to a network node in an upstream frequency band of a communication medium;
determining, based on a water-filling algorithm, an allocation of the total upstream transmit power amongst a plurality of channels used to transmit the upstream signals from the computing device to the network node in the upstream frequency band;
modifying the allocation of the total upstream transmit power based on determining that an amount of upstream transmit power allocated to at least one channel of the plurality of channels exceeds an amount of transmit power required to achieve a threshold signal-to-noise ratio (SNR) associated with the at least one channel at the network node; and
causing, based on the modified allocation of the total transmit power, the computing device to transmit the upstream signals to the network node.

17. The method of claim 16, wherein the modifying the allocation of the total upstream transmit power increases an average bit-loading across the plurality of channels.

18. The method of claim 16, wherein determining, based on the water-filling algorithm, the allocation of the total upstream transmit power amongst the plurality of channels comprises determining, for each of the plurality of channels, a separate transmit power level that is inversely proportional to an amount of path loss associated with the channel.

19. The method of claim 16, wherein the water-filling algorithm comprises a geometric water-filling algorithm.

20. The method of claim 16, wherein the threshold SNR comprises a SNR that is required for the network node to receive a signal via the at least one channel at a threshold modulation level.
